(19) United States
(12) Patent Application Publication
(10) Pub. No.: US 2015/0113338 A1
(43) Pub. Date: Apr. 23, 2015

(54) MONITORING DEVICE AND MONITORING METHOD

(71) Applicant: Panasonic Intellectual Property Management Co., Ltd., Osaka (JP)

(72) Inventors: Tooru Maruyama, Osaka (JP); Takeharu Yamamoto, Osaka (JP); Hisae Kato, Osaka (JP)

(73) Assignee: Panasonic Intellectual Property Management Co., Ltd., Osaka (JP)

(21) Appl. No.: 14/398,615

(22) PCT Filed: Oct. 1, 2013
(86) PCT No.: PCT/JP2013/005846

§ 371 Date: Nov. 3, 2014

(30) Foreign Application Priority Data
Oct. 2, 2012 (JP) 2012-220173

(51) Int. Cl. G06F 11/34; G06F 11/30

(52) U.S. Cl. CPC G06F 11/3466; G06F 11/3037
USPC 714/48

(57) ABSTRACT

A change necessity determination unit (12) determines necessity of change of a monitoring time interval of each performance item from a performance value of at least one performance item held by a performance value holding unit (11). A time interval computation unit (15) shortens a monitoring time interval of a performance item, for which the monitoring time interval is determined to need to be shortened by the change necessity determination unit (12), and extends a monitoring time interval of at least one performance item other than the performance item for which the monitoring time interval is determined to need to be shortened. A time interval update unit (16) updates the monitoring time interval held by the time interval holding unit (10), to the monitoring time interval of each performance item, which is computed by the time interval computation unit (15).

### TECHNICAL FIELD

The present invention relates to a technology of monitoring a plurality of performance items indicating the performance of an object to be monitored, at a predetermined time interval.

### BACKGROUND ART

Heretofore, in a case where performance information of an object to be monitored is obtained by shortening a time interval (polling interval) for monitoring a performance value of the object to be monitored, there is a problem in that communication for monitoring occurs wastefully, and a response to communication other than monitoring is lowered.

To cope with this problem, there is proposed a method of calculating a polling interval from time variation of a performance value of an object to be monitored, by using a parameter for calculating the polling interval (Patent Literature 1). Additionally, there is proposed a method of adjusting a target range or a degree of subsequent information collection on the basis of performance information collected from an object to be monitored, as necessary, in order to reduce an overhead for the object to be monitored when the performance information from the object to be monitored is acquired (Patent Literature 2). Furthermore, there is proposed a method of shortening a fault monitoring interval due to heart beat or the like, in order to promptly detect the fault of an object to be monitored (Patent Literature 3). Moreover, there is proposed a method of updating, for each object to be monitored, a monitoring interval of the object to be monitored in accordance with importance, by using a conversion dictionary holding a plurality of monitoring interval ranks according to importance and a monitoring interval for each monitoring interval rank (Patent Literature 4). Additionally, there is proposed a method of computing a monitoring interval by performing an computation request for monitoring interval change from a side of an object to be monitored to a monitoring server side, or performing an computation request for monitoring interval change from the monitoring server side to the side of the object to be monitored, in order to remotely monitor each device to be monitored at a suitable monitoring interval in accordance with the device specification, the use status, or the operation status of the device to be monitored (Patent Literature 5).

However, in the method of Patent Literature 1, the time interval to the next monitoring is merely calculated from the time variation of the performance value of the object to be monitored, and a coping method in a case where a large number of calculated performance values in which monitoring time interval is shortened are generated is not disclosed. Therefore, there is a problem that a communication amount required for monitoring increases, and an adverse influence is exerted on communication other than monitoring.

In the method of Patent Literature 2, the monitoring interval is set by designation by a user from a setting display screen, a dynamic calculation method is not disclosed, and there is a problem that a user's burden is increased in operation management of a system.

In the method of Patent Literature 3, information as a trigger for shortening the fault monitoring interval is detected from a network other than a network used in communication for monitoring, and there is a problem that capital investment for preparing a dedicated network is required.

In the method of Patent Literature 4, as the number of objects to be monitored increases, the dictionary capacity becomes large, and there is a problem that a time required for search processing of the dictionary increases.

In the method of Patent Literature 5, the computation request is transmitted/received between the object to be monitored and the monitoring server. The transmission side (object to be monitored) controls a trigger for transmitting the computation request, and therefore there is a problem that installation to a general system becomes difficult.

### CITATION LIST

### Patent Literature

Patent Literature 1: Japanese Patent Application Laid-open No. H11-154955
Patent Literature 2: Japanese Patent No. 4516306
Patent Literature 3: Japanese Patent Application Laid-open No. 2005-250626
Patent Literature 4: Japanese Patent No. 4600324
Patent Literature 5: Japanese Patent Application Laid-open No. 2010-134645

### SUMMARY OF INVENTION

An object of the present invention is to provide a monitoring device capable of suppressing increase in the monitoring load of the whole monitoring system even when a monitoring time interval for a performance item whose performance value proceeds to deteriorate is shortened, and the like.

A monitoring device according to an aspect of the present invention is a monitoring device for monitoring a plurality of performance items each indicating performance of an object to be monitored, at a predetermined time interval, which includes: a time interval holding unit that holds a monitoring time interval corresponding to each performance item; a monitoring manager unit that transmits, to the object to be monitored, a performance value acquisition command signal for acquiring a performance value of each performance item at the monitoring time interval held by the time interval holding unit, and receives the performance value of each performance item returned from the object to be monitored; a performance value holding unit that holds the performance value of each performance item, which is received by the monitoring manager unit; a determination unit that determines necessity of change of the monitoring time interval of each performance item from the performance value of at least one performance item held by the performance value holding unit; a time interval computation unit that shortens a monitoring time interval of a performance item for which the monitoring time interval is determined to need to be shortened by the determination unit, and extends a monitoring time interval of an arbitrary performance item other than the performance item for which the monitoring time interval is determined to need to be shortened; and a time interval update unit that updates the monitoring time interval held by the time interval holding unit, to the monitoring time interval of each performance item, which is computed by the time interval computation unit.

### BRIEF DESCRIPTION OF DRAWINGS

FIG. 1 is a block diagram showing a configuration of a monitoring system to which a monitoring device according to Embodiment 1 is applied.

FIG. 2 is a figure showing an example of a data configuration of a time interval table held by a time interval holding unit.

FIG. 3 is a figure showing an example of a laminated structure of an optical disk.

FIG. 4 is a figure showing an example of a data configuration of a performance value table held by a performance value holding unit.

FIG. 5 is a figure showing an example of a data configuration of a determination reference table held by a determination reference holding unit.

FIG. 6 is a graph for illustrating a method of determining the necessity of change for a performance item of “reproduction performance at a position of a radius of 30 mm of a layer 2”.

FIG. 7 are figures showing an example of a method of computing a monitoring time intervals.

FIG. 8 is a block diagram showing a configuration of a monitoring system to which a monitoring device according to Embodiment 2 is applied.

FIG. 9 are figures showing a process of a time interval computation unit 20 performed in a case of receiving a recomputation request from a priority setting unit.

FIG. 10 is a figure showing another aspect of the monitoring devices according to Embodiments 1 and 2.

FIG. 11 is a figure showing another aspect of the monitoring devices according to Embodiments 1 and 2.

FIG. 12 is a figure showing another aspect of the monitoring devices according to Embodiments 1 and 2.

FIG. 13 is a figure showing a configuration of a monitoring system provided with a plurality of monitoring agent units and a plurality of storage systems.

FIG. 14 is a block diagram of a monitoring system when a plurality of storage groups are employed as objects to be monitored.

### DESCRIPTION OF EMBODIMENTS

Hereinafter, embodiments of the present invention will be described.

### Embodiment 1

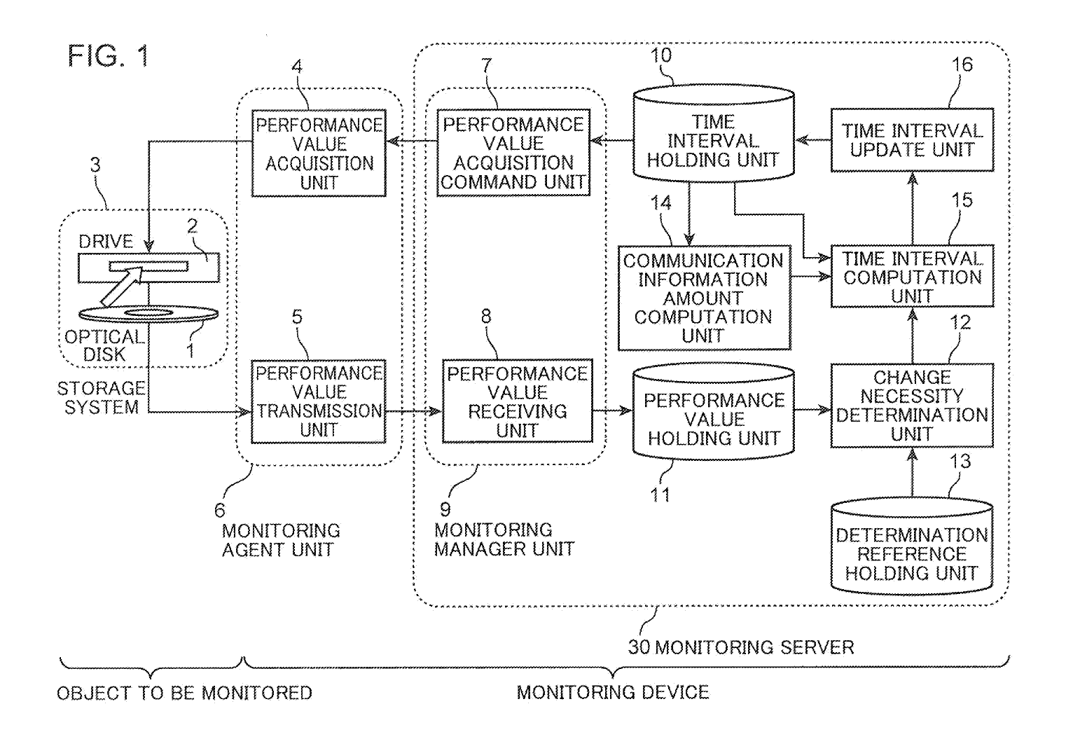

FIG. 1 is a block diagram showing a configuration of a monitoring system to which a monitoring device according to Embodiment 1 is applied. The monitoring system includes a monitoring device and an object to be monitored. The monitoring device is a device for monitoring a plurality of performance items each indicating performance of the object to be monitored, at predetermined time intervals. In FIG. 1, a monitoring agent unit 6 and a monitoring server 30 are an example of the monitoring device, and a storage system 3 is an example of the object to be monitored. In FIG. 1, an optical disk 1 is an example of an information recording carrier, a drive 2 is an example of an information recording device. In FIG. 1, a change necessity determination unit 12 and a determination reference holding unit 13 are an example of a determination unit. A monitoring manager unit 9 includes a performance value acquisition command unit 7, and a performance value receiving unit 8. The monitoring agent unit 6 includes a performance value acquisition unit 4, and a performance value transmission unit 5.

The monitoring agent unit 6 and the monitoring server 30 are communicably connected to each other through, for example, a predetermined network. As the predetermined network, a network such as Internet and LAN is employed. Then, the monitoring agent unit 6 and the monitoring server 30 are mutually communicated by using a communication protocol such as TCP/IP.

The monitoring agent unit 6 is communicably connected to the storage system 3 through, for example, a signal line or the like, or a predetermined network. Then, the monitoring agent unit 6 acquires a performance value from the storage system 3 by using, for example, SNMP (Simple Network Management Protocol).

The performance value acquisition command unit 7 reads a monitoring time interval of each of performance items held in a time interval holding unit 10, and transmits a performance value acquisition command signal to the performance value acquisition unit 4 of the monitoring agent unit 6 for each of the read monitoring time intervals. Herein, the performance value acquisition command signal is a signal for acquiring the performance value of each performance item from the object to be monitored.

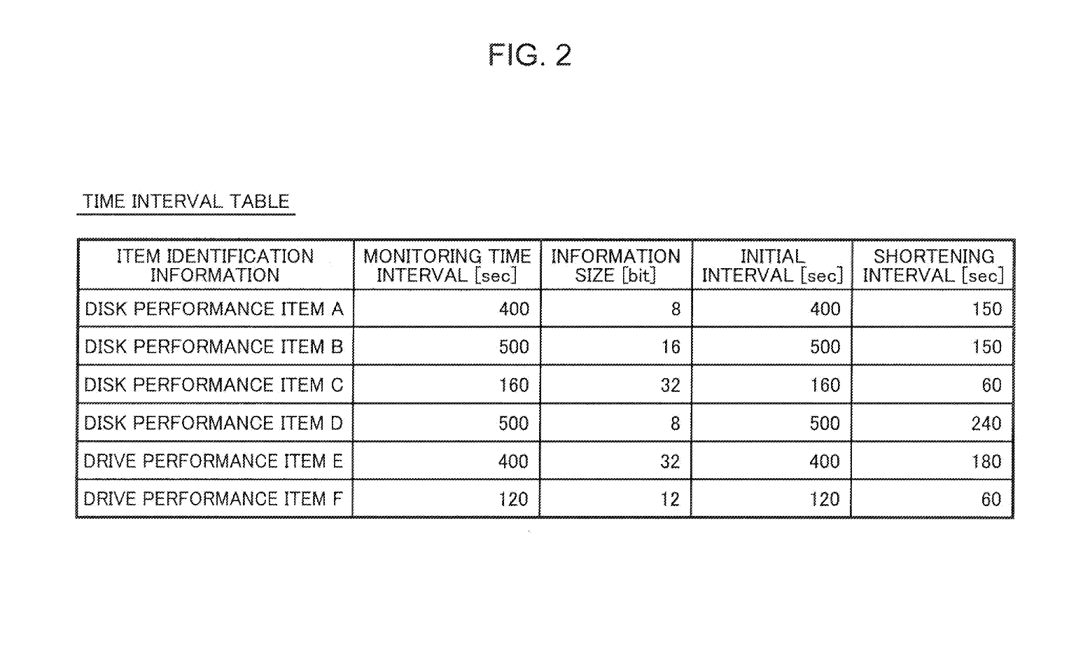

FIG. 2 is a figure showing an example of a data configuration of a time interval table held by the time interval holding unit 10. The time interval table is configured by relational database in which one record is allocated to each performance item, and “item identification information”, “monitoring time interval”, “information size”, “initial interval”, and “shortening interval” are registered in each record. In the example of FIG. 2, as the performance item, a disk performance item that is the performance item of the optical disk 1, and a drive performance item that is the performance item of the drive 2 are registered in the time interval table.

The “item identification information” is identification information for uniquely identifying the performance item. In the example of FIG. 2, four disk performance items of A to D, and two drive performance items of E to F are registered in the time interval table. However, this is only one example of the performance item, and various performance items may be registered in accordance with an object to be monitored. In the example of FIG. 2, as the “item identification information”, the wording indicating a summary of each performance item such as “disk performance item A” is described. However, a symbol string for uniquely identifying a performance item is actually employed.

The “monitoring time interval” indicates a monitoring time interval for each performance item that is currently set. Specifically, the monitoring time interval indicates a transmission interval of the performance value acquisition command signal. The “information size” indicates a communication information amount in communication between the monitoring server 30 and the monitoring agent unit 6 from the transmission of the performance value acquisition command signal to the acquisition of the performance value from the object to be monitored. Herein, a total of the number of bits of the performance value acquisition command signal and the number of bits of the performance value is employed as the information size. The “initial interval” indicates an initial value of the monitoring time interval. The “shortening time” indicates a monitoring time interval that has been shortened in a case where a monitoring time interval is shortened.

In the example of FIG. 2, “400 seconds”, “8 bits”, “400 seconds”, and “150 seconds” are registered as the “monitoring time interval”, the “information size”, the “initial interval”, and the “shortening interval” of the disk performance item A, respectively. Accordingly, in the disk performance item A, a performance value acquisition command signal is transmitted every 400 seconds. Then, in a case where the monitoring time interval of the disk performance item A is shortened, the monitoring time interval is shortened from 400 seconds to 150 seconds. The numerical values shown in FIG. 2 are merely examples, and other numerical values may be employed.

Returning to FIG. 1, the performance value acquisition unit 4 issues, to the storage system 3, an acquisition instruction for acquiring a performance value, when receiving the performance value acquisition command signal from the performance value acquisition command unit 7 of the monitoring manager unit 9. When receiving the acquisition instruction from the performance value acquisition unit 4, the storage system 3 acquires a performance value regarding the optical disk 1 or the drive 2 according to the acquisition instruction, and outputs the performance value to the performance value transmission unit 5.

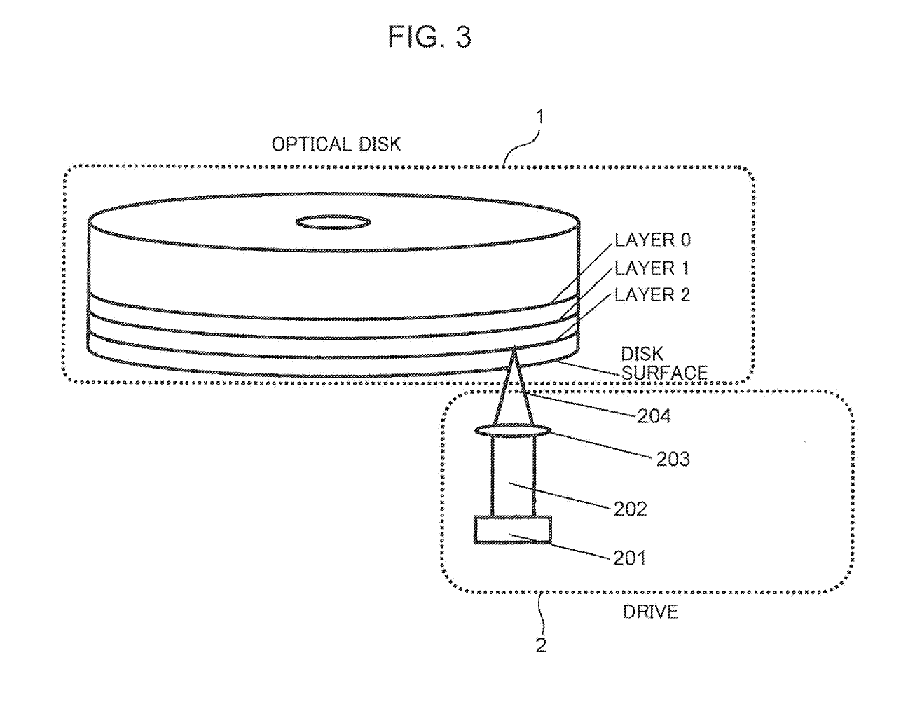

FIG. 3 is a figure showing an example of a laminated structure of the optical disk 1. The optical disk 1 has a plurality of layers that are information recording layers (information surfaces). The drive 2 includes a laser emission source 201, and an objective lens 203. Laser beams 202 emitted from the laser emission source 201 are converged by the objective lens 203, and the converged laser beam 204 enters each layer of the optical disk 1 from a disk surface side. Consequently, the drive 2 performs at least one of recording and reproduction of information to and from each layer. Layer numbers are given to the plurality of layers in order from a side far from a disk surface, like layer 0, layer 1, and layer 2.

Returning to FIG. 1, when receiving the performance value output from the storage system 3, the performance value transmission unit 5 transmits the performance value to the performance value receiving unit 8 of the monitoring manager unit 9. When receiving the performance value from the performance value transmission unit 5 of the monitoring agent unit 6, the performance value receiving unit 8 stores the received performance value in the performance value holding unit 11.

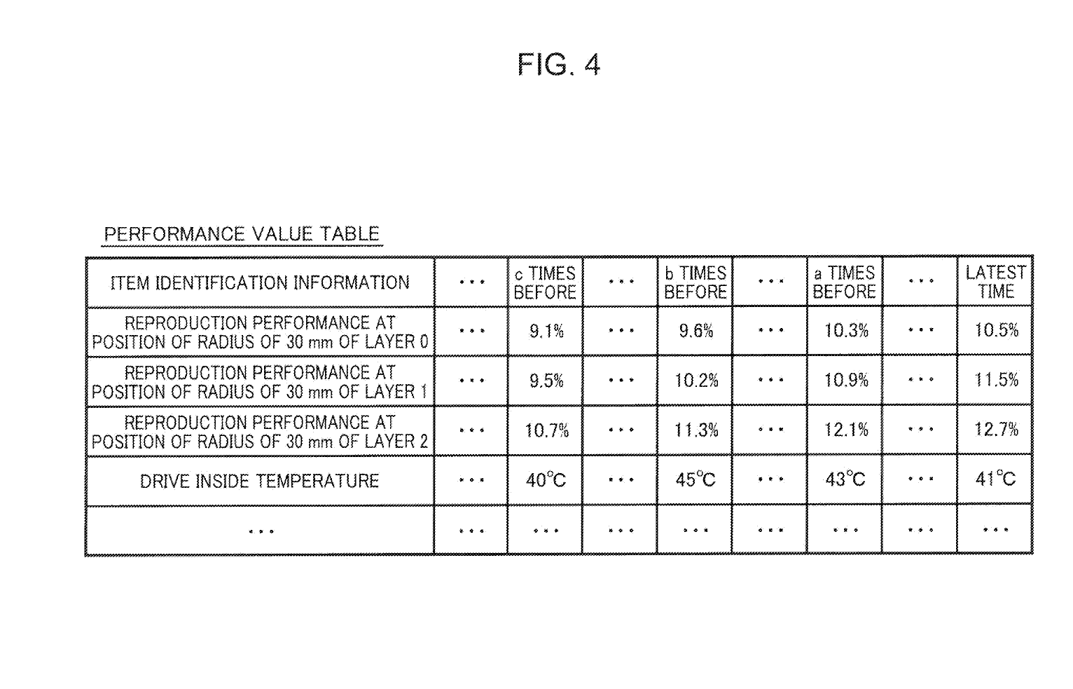

FIG. 4 is a figure showing an example of a data configuration of a performance value table held by the performance value holding unit 11. The performance value table is configured by, for example, relational database in which one record is allocated to each performance item, and holds a performance value of each performance item acquired by the performance value receiving unit 8 prior to a predetermined period from the present time, as a performance value history. In the example of FIG. 4, the performance value table includes a field of “item identification information”. The “item identification information” is identification information for uniquely identifying a performance item. For convenience of explanation, performance values in “latest time”, “a times before”, “b times before”, and “c times before” are representatively described in the example of FIG. 4. However, all performance values acquired in the predetermined period are actually registered in the performance value table. Performance values showing reproduction performance at a position of a radius of 30 mm of the layer 0 are held in time series in a record in the first line of the performance value table. Herein, as the performance values showing the reproduction performance, for example, an error rate is employed, and shows that the higher the numerical value is, the larger the deterioration degree of the reproduction performance is. In the record in the first line of the performance value table, “9.1%”, “9.6%”, “10.3%”, and “10.5%” are held as performance values in the “c times before”, the “b times before”, the “a times before”, the “latest time”, and it is found that the reproduction performance is deteriorated with time. Performance values showing reproduction performance at a position of a radius of 30 mm of the layer 1 are held in a record in the second line of the performance value table, performance values showing reproduction performance at a position of a radius of 30 mm of the layer 2 are held in a record in the third line of the performance value table. Similarly to the layer 0, it is found that the reproduction performance is deteriorated with time. In a record in the fourth line, a drive inside temperature is registered as a performance value. Herein, the drive inside temperature is an atmosphere temperature inside the drive 2.

In FIG. 4, the exemplified performance items are merely examples. For example, in the layer 0 to the layer 2, positions of one or a plurality of radii different from the position of a radius of 30 mm may be employed as the performance items. As long as the optical disk 1 includes layers of the layer 3 or more, positions of one or a plurality of radii of the layer 3 or more may be employed as the performance items.

For convenience of explanation, in the column of the item identification information in FIG. 4, the wording indicating the contents of the performance item is described. However, a symbol string for uniquely identifying the performance item is simply actually registered. In this case, a symbol string identical with the item identification information registered in the time interval table shown in FIG. 2 is simply registered in the performance value table shown in FIG. 4.

Returning to FIG. 1, the change necessity determination unit 12 determines necessity of the change of the monitoring time interval of each performance item, from the performance value history of each performance item registered in the performance value table held by the performance value holding unit 11. The example of timing of determination of the necessity of the change of the monitoring time interval by the change necessity determination unit 12 is as follows. For example, in a case where the change necessity determination unit 12 determines the necessity of the change of the monitoring time interval for the performance item whose performance value is acquired, each time the performance value of each performance item is acquired, and determines that the monitoring time interval for this performance item needs to be shortened, the change necessity determination unit 12 may determine the necessity of the change of the monitoring time interval of each of other all performance items. Or, the change necessity determination unit 12 may determine the necessity of the change of the monitoring time interval of each of all the performance items each time a performance value of a changed item, for which the monitoring time interval is the shortest, is acquired. Or, the change necessity determination unit 12 may determine the necessity of the change of the monitoring time interval of each of all the performance items each time a performance value of a changed item, for which the monitoring time interval is the longest, is acquired. Or, the change necessity determination unit 12 may determine the necessity of the change of the monitoring time interval of each of all the performance items each time a performance value of a specific performance item is acquired.

When determining the necessity of the change of the monitoring time interval of each performance item, the change necessity determination unit 12 simply determines the necessity of the change of the monitoring time interval of each performance item by using the performance value of each performance item registered in the performance value table. Or, the change necessity determination unit 12 may determine the necessity of the change of a monitoring time interval of a certain performance item (for example, the performance item of the optical disk 1) by using a performance value, and determine the necessity of the change of a monitoring time interval of other performance item (for example, the performance item of the drive 2) on the basis of the result of the necessity of the change of the certain performance item (for example, the performance item of the optical disk 1) without using a performance value.

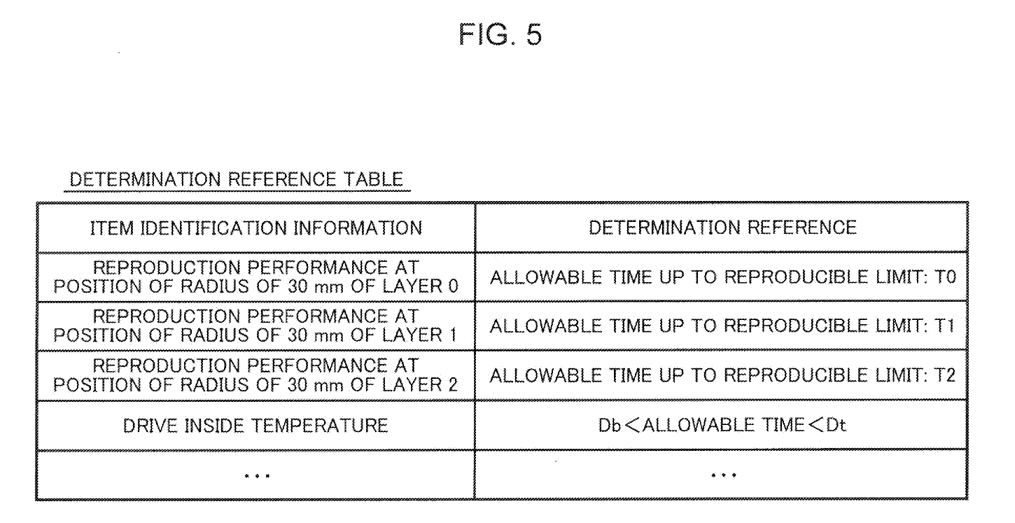

Herein, in a case where the change necessity determination unit 12 determines the necessity of the change of a monitoring time interval of a certain performance item, the change necessity determination unit 12 reads a determination reference corresponding to one performance item from a determination reference table shown in FIG. 5, and determines the necessity of the change of a monitoring time interval of the one performance item in accordance with the read determination reference.

FIG. 5 is a figure showing an example of a data configuration of the determination reference table held by the determination reference holding unit 13. The determination reference table is configured by relational database in which one record is allocated to each performance item, and a determination reference preset for each performance item is registered. In three records from the first line to the third line of the determination reference table, determination references corresponding to reproduction performance at positions of a radius of 30 mm of the layer 0 to the layer 2 are registered. Herein, as the determination references, allowable times up to a reproducible limit are employed. Allowable times T0, T1 and T2 are registered for the layer 0 to the layer 2, respectively. In a record in the fourth line of the determination reference table, a determination reference for a drive inside temperature is registered. Herein, as the determination reference, an allowable temperature defined by a temperature range in which the temperature is higher than a lower limit temperature Db and is lower than an upper limit temperature Dt is employed. For convenience of explanation, in the column of the “item identification information” in FIG. 5, the wording indicating the contents of the performance item is described. However, a symbol string for uniquely identifying the performance item is actually registered.

For example, in a case where the necessity of the change of a monitoring time interval of a performance item of the “reproduction performance at a position of a radius of 30 mm of the layer 2” is determined, the change necessity determination unit 12 reads T2, which is a determination reference corresponding to this performance item, from the determination reference table shown in FIG. 5, and determines the necessity of the change of the monitoring time interval for this performance item.

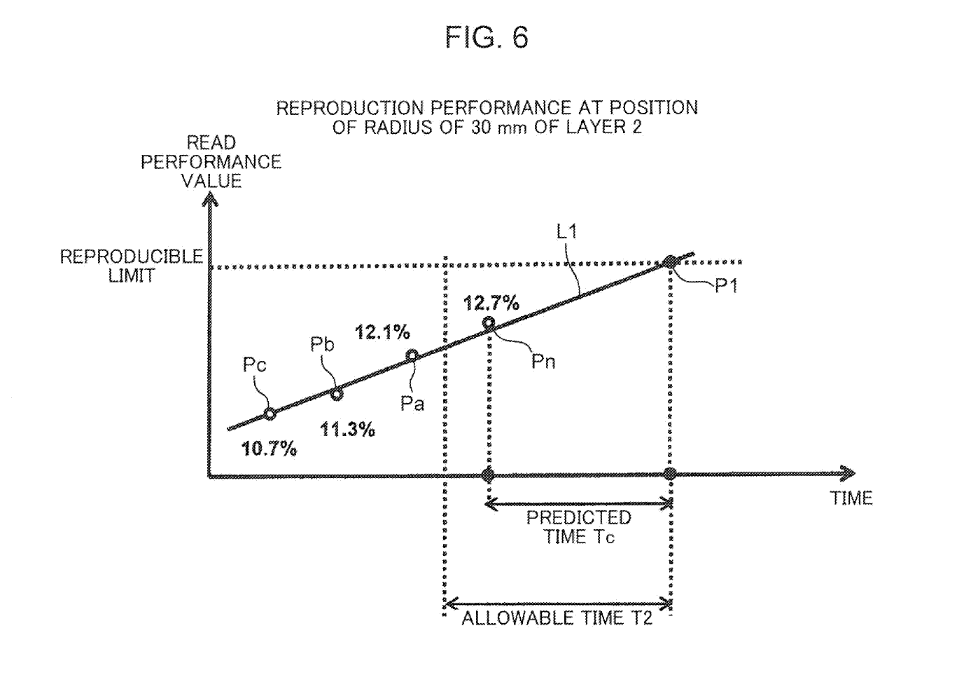

Hereinafter, taking the performance item of the “reproduction performance at a position of a radius of 30 mm of the layer 2” as an example, a method of determining the necessity of the change of the monitoring time interval for the performance item will be described in detail with reference to FIG. 4, FIG. 5 and FIG. 6. First, the change necessity determination unit 12 reads all performance value history ( . . . , 10.7%, . . . , 11.3%, . . . , 12.1%, . . . , 12.7%) of the “reproduction performance at a position of a radius of 30 mm of the layer 2”, which is registered in the performance value table shown in FIG. 4.

Then, the change necessity determination unit 12 reads “allowable time up to a reproducible limit: T2”, which is a determination reference corresponding to the “reproduction performance at a position of a radius of 30 mm of the layer 2” in the determination reference table shown in FIG. 5.

FIG. 6 is a graph for illustrating the method of determining the necessity of the change for the performance item of the “reproduction performance at a position of a radius of 30 mm of the layer 2”. In FIG. 6, the horizontal axis denotes time, and the vertical axis denotes a performance value history. The origin of the graph in FIG. 6 denotes, for example, time when the storage system 3 being an object to be monitored starts working.

The change necessity determination unit 12 calculates an approximation straight line L1 shown in FIG. 6, from the performance value history for the performance item of “reproduction performance at a position of a radius of 30 mm of the layer 2” read from the performance value table. Herein, the change necessity determination unit 12 simply calculates the approximation straight line L1, for example, by using a least-squares method.

The change necessity determination unit 12 calculates a predicted time Tc from a present time point to a reproducible limit. The reproducible limit is a performance value showing a limit capable of reproducing data recorded at the position of a radius of 30 mm of the layer 2, and a value empirically obtained is employed. Herein, for example, while acquisition time at a measurement point Pn in the latest time is defined as the present time point, the change necessity determination unit 12 simply obtains time from the present time point up to a reaching point P1 where the approximation straight line L1 reaches the reproducible limit, as the predicted time Tc. That is, the change necessity determination unit 12 obtains the predicted time Tc by using an extrapolation method.

When the predicted time Tc is not greater than an allowable time T2, the change necessity determination unit 12 determines that the monitoring time interval needs to be changed. On the other hand, when the predicted time Tc is greater than the allowable time T2, the change necessity determination unit 12 determines that the monitoring time interval of the relevant performance item does not need to be changed. Herein, as the allowable time T2, for example, preset time showing that the deterioration of the relevant performance item proceeds, and the predicted time Tc becomes not greater than time required for reinforcing monitoring is employed.

In the example of FIG. 6, the predicted time Tc up to the reproducible limit is not greater than the allowable time T2, and therefore the change necessity determination unit 12 determines that the monitoring time interval for the performance item of the “reproduction performance at a position of a radius of 30 mm of the layer 2” needs to be shortened. Predicted times calculated at a measurement point Pa, a measurement point Pb, and a measurement point Pc of performance values in a times before, b times before, and c times before respectively are greater than the allowable time T2, and therefore the change necessity determination unit 12 determines that the monitoring time intervals of the relevant performance item do not need to be changed.

Herein, the “reproduction performance at a position of a radius of 30 mm of the layer 2” is a performance item related to the optical disk 1. Therefore, in a case where the change necessity determination unit 12 determines that the monitoring time interval for this performance item needs to be shortened, the change necessity determination unit 12 simply determines that monitoring time intervals for other performance items (for example, the “reproduction performance at a position of a radius of 30 mm of the layer 0” and the “reproduction performance at a position of a radius of 30 mm of the layer 1”) related to the optical disk 1 need to be extended. In this case, the change necessity determination unit 12 simply determines that a monitoring time interval for a performance item (for example, the “drive inside temperature”) related to the drive 2 does not need to be changed.

That is, in a case where the change necessity determination unit 12 determines that a monitoring time interval for a certain performance item of the optical disk 1 needs to be changed, the change necessity determination unit 12 simply determines that monitoring time intervals for one or a plurality of performance items among other performance items of the optical disk 1 are extended, and simply determines that monitoring time intervals for the performance items of the drive 2 are not changed. Herein, in a case where the change necessity determination unit 12 determines that a predetermined number (for example, two) of performance items among the performance items of the optical disk 1 need to be shortened, the change necessity determination unit 12 may determine that monitoring time intervals for the same number of performance items (for example, two) as the number of the performance items determined that shortening is needed, among remaining performance items of the optical disk 1 need to be extended, and may determine that monitoring time intervals for other performance items are not changed.

The change necessity determination unit 12 determines the necessity of the change of the monitoring time interval for each performance item as described above, and outputs the determination result to a time interval computation unit 15. Herein, in a case where the change necessity determination unit 12 determines that a monitoring time interval for a certain performance item needs to be shortened, the change necessity determination unit 12 simply outputs the determination result to the time interval computation unit 15, and requests the computation of the monitoring time interval. Consequently, unnecessary computation process for a monitoring time interval can be prevented from occurring, and a processing load of the time interval computation unit 15 can be reduced.

The communication information amount computation unit 14 calculates a communication information amount per unit time for each performance item registered in the time interval table held by the time interval holding unit 10. Then, the time interval computation unit 15 computes the monitoring time interval such that the communication information amount per unit time calculated by the communication information amount computation unit 14 is not greater than a predetermined value.

Hereinafter, an example of the computation of the communication information amount per unit time will be described in detail with reference to FIG. 2. First, the communication information amount computation unit 14 computes a communication information amount per unit time of each performance item by dividing the information size of each performance item by the monitoring time interval. Respective communication information amounts per unit time of the disk performance items A to D shown in FIG. 2, and respective communication information amounts per unit time of the drive performance items E to F shown in FIG. 2 are calculated as follows.

Communication information amount per unit time in the disk performance item A

8 bit/400 sec=0.02 bps [Expression A]

Communication information amount per unit time in the disk performance item B

16 bit/500 sec=0.032 bps [Expression B]

Communication information amount per unit time in the disk performance item C

32 bit/160 sec=0.2 bps [Expression C]

Communication information amount per unit time in the disk performance item D

8 bit/500 sec=0.016 bps [Expression D]

Communication information amount per unit time in the drive performance item E

32 bit/400 sec=0.08 bps [Expression E]

Communication information amount per unit time in the drive performance item F

12 bit/120 sec=0.1 bps [Expression F]

Then, the communication information amount computation unit 14 calculates a total of the communication information amounts per unit time of the respective performance items. In the example of FIG. 2, the total of the communication information amounts per unit time of the respective performance items is calculated as follows.

(Communication Information Amount Per Unit Time According To Monitoring)

[Expression A]+[Expression B]+[Expression C]+[Expression D]+[Expression E]+[Expression F]=0.448 bps [Expression SUM]

Then, the communication information amount computation unit 14 outputs the calculated total of the communication information amounts per unit time of the respective performance items to the time interval computation unit 15.

The time interval computation unit 15 calculates new monitoring time intervals by using the determination result output from the change necessity determination unit 12, and the communication information amounts output from the communication information amount computation unit 14, and the monitoring time intervals for the respective performance items read from the time interval holding unit 10. Herein, 0.448 bps calculated in [Expression SUM] is defined as a predetermined value. Then, the time interval computation unit 15 calculates a monitoring time interval of each performance item such that the total of the communication information amounts per unit time of the respective performance items is 0.448 bps.

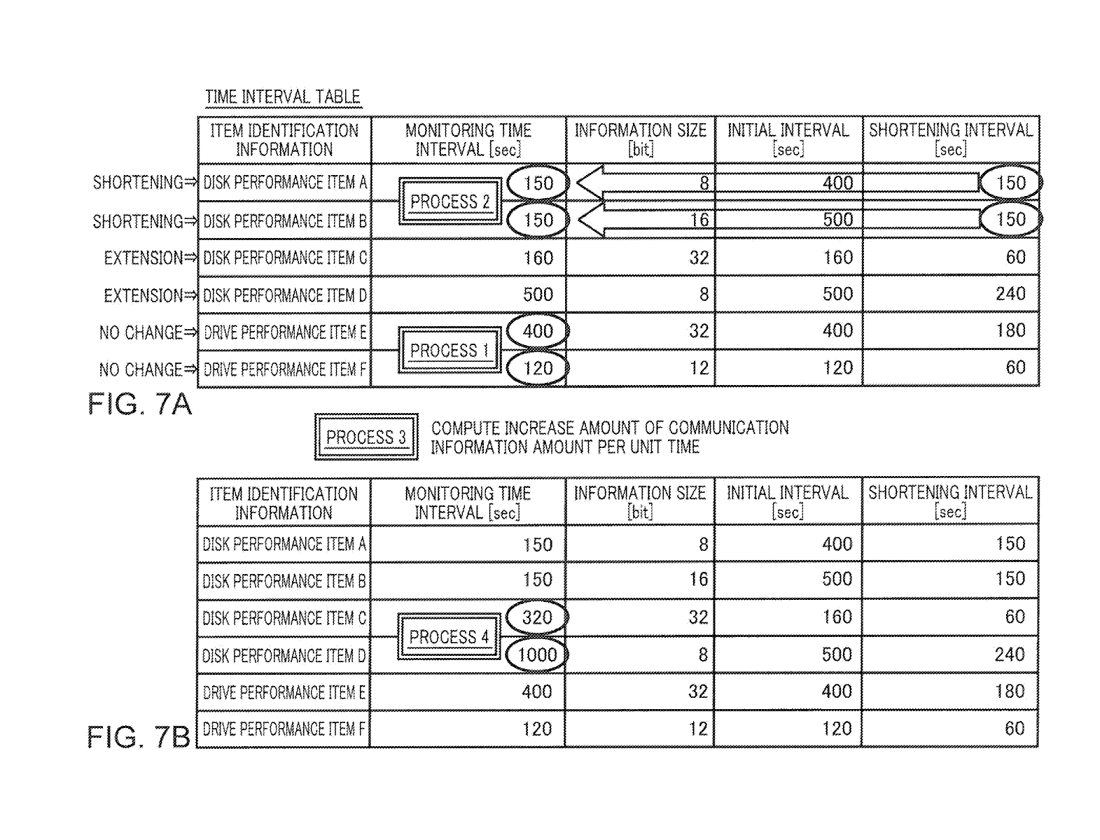

An example of the computation of the monitoring time interval will be described in detail with reference to FIG. 2 and FIG. 7. FIG. 7 are figures showing an example of a method of computing the monitoring time intervals. FIG. 7A shows a state where the monitoring time intervals of the disk performance items A and B, and the monitoring time intervals of the drive performance items E and F are established, and FIG. 7B shows a state where the monitoring time intervals of all performance items are established.

Herein, it is assumed that the change necessity determination unit 12 determines that the monitoring time intervals of the disk performance item A and the disk performance item B shown in FIG. 2 need to be shortened. Additionally, it is assumed that the change necessity determination unit 12 determines that the monitoring time intervals of the disk performance item C and the disk performance item D shown in FIG. 2 need to be extended. Furthermore, it is assumed that the change necessity determination unit 12 determines that the monitoring time intervals of the drive performance item E and the drive performance item F shown in FIG. 2 do not need to be changed.

First, the time interval computation unit 15 establishes the monitoring time intervals of the drive performance item E and the drive performance item F, which are determined not to need to be changed, with no change (Process 1 in FIG. 7A).

Then, the time interval computation unit 15 changes the monitoring time intervals of the disk performance item A and the disk performance item B, which are determined to need to be shortened, to time intervals registered in the field of the shortening interval (Process 2 in FIG. 7A).

Then, the time interval computation unit 15 computes increase amounts of communication information amounts per unit time after the monitoring time intervals of the disk performance item A and the disk performance item B are shortened (Process 3 in FIG. 7). In the example of FIG. 7A, the respective monitoring time intervals of the disk performance item A and the disk performance item B are shortened to 150 sec, and therefore the respective communication information amounts per unit time of the disk performance item A and the disk performance item B are calculated by the following [Expression A′] and [Expression B′].

(Communication Information Amount Per Unit Time In Disk Performance Item A)

8 bit/150 sec=0.053333 bps [Expression A′]

(Communication Information Amount Per Unit Time In Disk Performance Item B)

16 bit/150 sec=0.106667 bps [Expression B′]

A total of the communication information amounts per unit time of the respective performance items after the monitoring time intervals of the disk performance item A and the disk performance item B are shortened is calculated by the following [Expression SUM′].

(Communication Information Amount Per Unit Time After Shortening)

[Expression A′]+[Expression B′]+[Expression C]+[Expression D]+[Expression E]+[Expression F]=0.556 bps [Expression SUM′]

Accordingly, an increase amount of the communication information amount per unit time due to the shortening of the monitoring time intervals of the disk performance item A and the disk performance item B is calculated by the following [Expression INC].

(Increase Amount Of Communication Information Amount Per Unit Time)

[Expression SUM′]−[Expression SUM]=0.108 bps [Expression INC]

In order to suppress a communication information amount per unit time in monitoring to the predetermined value or less, this increase amount is simply absorbed in the performance item, for which the monitoring time interval is determined to need to be extended. Therefore, the time interval computation unit 15 distributes the increase amount computed by [Expression INC], to the disk performance item C and the disk performance item D, for which the monitoring time intervals are determined to need to be extended. As this method of distributing the increase amount, for example, a method of distributing an increase amount to each performance item for which the monitoring time interval is determined to need to be extended, in accordance with a ratio of an information communication amount per unit time of each performance item for which the monitoring time interval is determined to need to be extended can be employed.

Herein, a communication information amount per unit time of the disk performance item C is 0.2 bps computed by [Expression C], and a communication information amount per unit time of the disk performance item D is 0.016 bps computed by [Expression D]. Therefore, the time interval computation unit 15 distributes 0.108 bps, which is an increase amount computed by the [Expression INC], to the disk performance item C and the disk performance item D in a ratio of 0.2:0.016. This is merely an example, and 0.108 bps, which is an increase amount computed by the [Expression INC] may be distributed to the disk performance item C and the disk performance item D in various ratios such as 1:1, 2:1, and 3:1.

Specifically, a communication information amount per unit time to be absorbed by the disk performance item C is expressed by the following expression [LOAD_C].

(Communication Information Amount Per Unit Time To Be Absorbed By Disk Performance Item C)

0.108×([Expression C]/([Expression C]+[Expression D]))=0.1 bps [Expression LOAD_C]

Additionally, a communication information amount per unit time to be absorbed by the disk performance item D is expressed by the following expression [LOAD_D].

(Communication Information Amount Per Unit Time To Be Absorbed By Disk Performance Item D)

0.108×([Expression D]/([Expression C]+[Expression D]))=0.008 bps [Expression LOAD_D]

In order to suppress the communication information amount per unit time in monitoring to the predetermined value or less, the communication information amounts computed by [Expression LOAD_C] and [Expression LOAD_D] are simply deducted from the communication information amounts per unit time before the extension of the disk performance item C and the disk performance item D.

Therefore, the time interval computation unit 15 calculates a new communication information amount per unit time of the disk performance item C by [Expression C′].

(New Communication Information Amount Per Unit Time Of Disk Performance Item C)

[Expression C]−[Expression LOAD_{—}C]=0.2 bps−0.1 bps=0.1 bps [Expression C′]

The time interval computation unit 15 calculates a new communication information amount per unit time of the disk performance item D by [Expression D′].

(New Communication Information Amount Per Unit Time Of Disk Performance Item D)

[Expression D]−[Expression LOAD_{—}D]=0.016 bps−0.008 bps=0.008 bps [Expression D′]

Then, the time interval computation unit 15 divides the information size of the disk performance item C by [Expression C′] to calculate a monitoring time interval after the extension of the disk performance item C, and divides the information size of the disk performance item D by [Expression D′] to calculate a monitoring time interval after the extension of the disk performance item D (Process 4 in FIG. 7).

(Monitoring Time Interval After Extension Of Disk Performance Item C)

32 bit/[Expression C′]=320 sec

(Monitoring Time Interval After Extension Of Disk Performance Item D)

8 bit/[Expression D′]=1000 sec

The time interval computation unit 15 outputs the computation result of the thus calculated monitoring time interval of each performance item, to a time interval update unit 16.

The time interval update unit 16 updates the monitoring time interval of each performance item, which is held in the time interval holding unit 10, using the computation result received from the time interval computation unit 15. In the above example, as shown in FIG. 7B, the time interval update unit 16 updates the monitoring time interval of the disk performance item A from 400 sec to 150 sec, and updates the monitoring time interval of the disk performance item B from 500 sec to 150 sec. Additionally, the time interval update unit 16 updates the monitoring time interval of the disk performance item C from 160 sec to 320 sec, and updates the monitoring time interval of the disk performance item D from 500 sec to 1000 sec. The monitoring time intervals of the drive performance item E and the drive performance item F are determined not to be changed, and therefore are kept to 400 sec and 120 sec.

Consequently, a total of information communication amounts per unit time of all performance items after updating is 8/150+16/150+32/320+8/1000+32/400+12/120=0.053333+0.106667+0.1+0.008+0.08+0.1=0.448 bps, which is the same value as the information communication amount per unit time before updating shown in [Expression SUM]. It is found that the information communication amount per unit time after updating is not greater than the predetermined value (0.448 bps).

As described above, in a case where it is determined that the monitoring time interval of any one or a plurality of performance items need to be shortened, the increase amount of the communication information amount per unit time is absorbed in the one or plurality of performance items, for which the monitoring time intervals are determined to need to be extended, such that the total of the communication information amounts per unit time of all performance items is not greater than the predetermined value. Therefore, even when a monitoring time interval for a performance item in which the deterioration of the performance value is progressing is shortened, the monitoring time interval can be changed without increasing a monitoring load (a communication load required for monitoring, or a processing load required for monitoring) to an object to be monitored. As a result, it is possible to perform necessary monitoring while keeping a communication load required for monitoring the whole of a system to a predetermined value or less.

In the example of FIG. 7, the monitoring time intervals are changed such that the total of the communication information amounts per unit time of all performance items is not greater than the predetermined value. However, this is merely an example, and the monitoring time intervals may be changed such that an average of the communication information amounts per unit time of all performance items is not greater than the predetermined value.

In this embodiment, the following aspects may be employed.

(1-1) In this embodiment, in a case where the change necessity determination unit 12 determines that a monitoring time interval for any of the performance items related to the optical disk 1 needs to be shortened, the change necessity determination unit 12 determines that monitoring time intervals for the remaining performance items of the optical disk 1 need to be extended, and determines that monitoring time intervals for the performance items related to the drive 2 do not need to be changed. However, this is merely an example. In a case where the change necessity determination unit 12 determines that a monitoring time interval for any of the performance items related to the drive 2 needs to be shortened, the change necessity determination unit 12 may determine that monitoring time intervals for the remaining performance items of the drive 2 need to be extended, and may determine that monitoring time intervals for the performance items related to the optical disk 1 do not need to be changed.

For example, in a case where the change necessity determination unit 12 determines that the monitoring time interval for the drive performance item E needs to be shortened, the change necessity determination unit 12 simply determines that the monitoring time interval for the drive performance item F needs to be extended, and simply determines that the monitoring time intervals for the disk performance items A to D need not to be changed. In this case, the time interval computation unit 15 shortens the monitoring time interval of the drive performance item E from 400 sec to 180 sec in accordance with the time interval table in FIG. 2. Then, the time interval computation unit 15 simply makes the drive performance item F absorb the increase amount of the information communication amount per unit time due to this shortening, by using the above method.

(1-2) In a case where an object to be monitored is redundantly configured from a plurality of the optical disks 1 and a plurality of the drives 2, the change necessity determination unit 12 may determine that monitoring time intervals for performance items of the number of the optical disks 1 and the number of the drives 2 (the usable number) expected to be restorable even when a failure occurs need to be extended.

For example, it is assumed that there are five storage systems 3 (3_1, 3_2, 3_3, 3_4, 3_5). Even when failures occur in two storage systems 3 of the five storage systems 3, information recorded in optical disks 1 of the two storage system 3 where the failure has occurred can be restored from information recorded in optical disks 1 of the remaining three storage systems. Then, the change necessity determination unit 12 determines that monitoring time intervals for certain performance items of the storage systems 3_1 and 3_2 need to be shortened. In this case, the change necessity determination unit 12 simply determines that monitoring time intervals for a part of or all of performance items of the storage systems 3_3 to 3_5, which are not determined to need to be shortened, are extended.

(1-3) In a case where the number of accesses from an external device (not shown) to the storage system 3 (object to be monitored) is a predetermined number or more, or an access amount is a predetermined amount or more, read/write performance to the optical disk 1 is deteriorated. Therefore, the change necessity determination unit 12 may consider that accesses from the external device to the storage system 3 repeatedly occur. Then, the change necessity determination unit 12 may determine that the monitoring time intervals for the performance items related to the optical disk 1 need to be shortened, and may determine that the monitoring time intervals for the performance items related to the drive 2 need to be extended or do not need to be changed.

Specific description will be made with reference to FIG. 2. In a case where the number of accesses from the external device is a predetermined value or more, or the access amount is a predetermined amount or more, the change necessity determination unit 12 determines that the monitoring time intervals of the disk performance items A to D need to be shortened, and determines that the monitoring time intervals of the drive performance items E and F need to be extended, or do not need to be changed. In this case, the time interval computation unit 15 may shorten the disk performance items A to D by the shortening intervals registered in the time interval table of FIG. 2, and may make the drive performance items E and F absorb the increase amount of the communication information amounts per unit time of all performance items due to shortening by using the above method of FIG. 7B. Consequently, the communication information amounts per unit time of all performance items can be not greater than the predetermined value.

Or, the time interval computation unit 15 may shorten the disk performance items A to D by the shortening intervals registered in the time interval table of FIG. 2, and may make the drive performance items E and F absorb the total of shortening amounts of the monitoring time intervals of the disk performance items A to D. In the example of FIG. 2, the shortening amounts of the disk performance items A to D are 250 (=400−150), 350 (=500−150), 100 (=160−60), and 260 (=500−240), respectively, and therefore the total of the shortening amounts becomes 960 (=250+350+100+260). Accordingly, the time interval computation unit 15 distributes 960, which is the total of the shortening amounts, to the drive performance items E and F, to obtain increase amounts of the monitoring time intervals of the drive performance items E and F. In this case, the time interval computation unit 15 simply distributes the total of the shortening amounts in accordance with, for example, a ratio of presently set monitoring time intervals of the drive performance items E and F. In the example of FIG. 2, the present monitoring time intervals of the drive performance items E and F are 400 and 120, and therefore the time interval computation unit 15 obtains Δs1=960×(400/520) as the increase amount of the monitoring time interval of the drive performance item E, and obtains Δs2=960×(120/520) as the increase amount of the monitoring time interval of the drive performance item F. Then, the time interval computation unit 15 obtains a value obtained by adding an increase amount Δs1 of the drive performance item E to 400 being the present monitoring time interval of the drive performance item E (=400+Δs1), as the monitoring time interval of the drive performance item E, and obtains a value obtained by adding an increase amount Δs2 of the drive performance item F to 120 being the present monitoring time interval of the drive performance item F (=120+Δs2), as the monitoring time interval of the drive performance item F.

As the external device, for example, an information processor communicably connected to the storage system 3 through a network can be employed. As the information processor, for example, a portable information processor such as a Smartphone and a tablet terminal may be employed, or a stationary information processor such as a desktop computer may be employed.

The change necessity determination unit 12 simply measures time from when the performance value acquisition command unit 7 transmits a performance value acquisition command signal for a certain performance item to when the performance value receiving unit 8 receives a performance value of the performance item, and determines that the number of accesses or an access amount is a predetermined value or more when the measured time is a predetermined time or more. That is, in a case where the number of accesses to the storage system 3 or the access amount is large, the processing load of the storage system 3 is increased, and communication traffic of the network connected to the storage system 3 is increased, and therefore a response of the performance value responded from the storage system 3 in response to the performance value acquisition command signal is delayed. Therefore, the change necessity determination unit 12 measures time from when the performance value acquisition command signal of the certain performance item is transmitted to when the performance value of the performance item is received, so that the number of accesses from the external device to the storage system 3, or the access amount can be measured.

Or, the change necessity determination unit 12 may monitor a WRITE command and a READ command issued to the storage system 3, and detect the frequency access number per unit time of these commands, or detect data size transmitted and received by the issuance of these command as the access amount. For example, when the WRITE command and the READ command are issued from the external device to the storage system 3, the change necessity determination unit 12 simply monitors these commands by transmitting the fact from the monitoring agent unit 6 to the monitoring server 30.

(1-4) The change necessity determination unit 12 may determine that a monitoring time interval of a performance item related to a layer close to the disk surface among the performance items related to the optical disk 1 needs to be shortened, and determine that a monitoring time interval of a performance item related to a layer far from the disk surface needs to be extended.

Herein, the reason why the performance item related to the layer close to the disk surface is preferentially monitored is that, for example, the number of times of applying light increases as the layer is closer to the disk surface, and the layer close to the disk surface is deteriorated faster than the layer far from the disk surface. That is, in a case where light is applied to a certain layer and information is read, it is necessary to transmit light to a layer located on the disk surface side compared to the layer.

For example, in the example of FIG. 3, it is assumed that the optical disk 1 is configured by stacking six layers, namely a layer 5, a layer 4, a layer 3, a layer 2, a layer 1, and a layer 0 from the disk surface in this order. Then, it is assumed that the number of accesses or the access amount of the optical disk 1 is a predetermined value or more. In this case, the change necessity determination unit 12 simply decides that the number of layers, for which the monitoring time intervals are to be shortened, in accordance with the number of accesses or the access amount.

Herein, the change necessity determination unit 12 simply decides the number of layers, for which the monitoring time intervals are to be shortened, such that as a value obtained by deducting the predetermined value from the number of accesses or the access amount is increased, the number of layers, for which the monitoring time intervals are to be shortened, is increased. Then, the change necessity determination unit 12 simply decides the layers decided as the layers to be shortened from layers close to the disk surface of optical disk 1, as the layers, for which the monitoring time intervals are to be shortened. Then, the change necessity determination unit 12 simply decides the same number of layers as the number of the layers decided as objects to be shortened, as the number of layers, for which the monitoring time intervals are to be extended, and decides the layers decided as the layers to be extended from layers far from the disk surface, as the layers, for which the monitoring time intervals are to be extended.

For example, when the layer 5 and the layer 4 are decided as the layers to be shortened, the layer 0, and the layer 1 are decided as the layers to be extended. In a case where the number of the layers decided as the layers to be shortened is greater than a half of all the layers configuring the optical disk 1, the change necessity determination unit 12 simply determines remaining all layers as the layers to be extended. For example, in a case where the layer 5, the layer 4, the layer 3, and the layer 2 are determined as the layers to be shortened, the layer 0, and the layer 1 are determined as the layers to be extended. As to the layers decided as the layer to be shortened, the change necessity determination unit 12 simply decides all of or a part of performance items related to the layer, as the layers to be shortened. Additionally, as to the layers decided as the layer to be extended, the change necessity determination unit 12 simply decides all of or a part of performance items related to the layer, as the layers to be extended.

(1-5) In the example of FIG. 1, the communication information amount computation unit 14 calculates the communication information amount per unit time. However, the present invention is not limited to this. For example, a communication information amount measurement device that measures the communication information amount per unit time may be provided between the monitoring agent unit 6 and the monitoring manager unit 9, and the time interval computation unit 15 may calculate the monitoring time interval of each performance item such that a communication information amount per unit time measured by this communication information amount measurement device is not greater than the predetermined value.

(1-6) The monitoring agent unit 6 may measure an acquisition processing time from the acquisition start of the performance value of each performance item from the storage system 3 to acquisition completion, and transmit the measurement result to the monitoring manager unit 9 as one of the performance items. Then, the time interval computation unit 15 may calculate the monitoring time interval of each performance item such that the acquisition processing time shown by this measurement result is not greater than a predetermined value.

Herein, the time interval computation unit 15 may cause the monitoring agent unit 6 to measure acquisition processing times for all performance items, and calculate the monitoring time interval of each performance item such that any one of the measured acquisition processing times is not greater than a predetermined value, or may calculate the monitoring time interval of each performance item such that the average of the measured acquisition processing times of all performance items is not greater than a predetermined value.

In the example of FIG. 2, it is assumed that the time interval computation unit 15 determines that an acquisition processing time of a certain performance item, which is measured by the monitoring agent unit 6, is greater than the predetermined value. In this case, the time interval computation unit 15 simply increases the monitoring time intervals of all performance items shown in FIG. 2, by a predetermined time width. Then, the time interval computation unit 15 simply repeatedly performs a process for increasing the monitoring time intervals of all performance items shown in FIG. 2, by the predetermined time width, until the acquisition processing time of any one of the performance items measured by the monitoring agent unit 6 becomes not greater than the predetermined value.

Herein, a case where the time interval computation unit 15 determines that an acquisition processing time of a certain performance item measured by the monitoring agent unit 6 is greater than the predetermined value, in a case where the change necessity determination unit 12 determines that the monitoring time interval for the disk performance item A needs to be shortened, is considered. In this case, the time interval computation unit 15 may extend the monitoring time intervals for all performance items until the acquisition processing times are not greater than the predetermined value, regardless of the determination result indicating that the monitoring time interval for the disk performance item A needs to be shortened, or may extend the monitoring time interval for remaining all performance items other than the disk performance item A.

(1-7) In this embodiment, as the reproduction performance of the optical disk 1, the error rate is shown. However, for example, Jitter, MLSE (Maximum Likelihood Sequence Estimation) showing reading performance by maximum likelihood sequence estimation, a retry frequency of a reproduction process during information reproduction of the optical disk 1, or the like may be employed as the reproduction performance.

(1-8) In this embodiment, as the performance items, the reproduction performance of the optical disk 1, and the inside temperature of the drive 2 are shown. However, the present invention is not limited to these. For example, recording performance may be employed as the performance item in place of the reproduction performance. As the recording performance, a verify frequency, a retry frequency in a recording process, an occurrence frequency of alternate recording to another region, an error rate in a recording process, or the like can be employed. Additionally, as the performance item of the drive 2, for example, a laser driving current, a motor current, driving times of various mechanisms, or the like may be employed.

(1-9) In FIG. 3, the optical disk 1 is configured by the three layers, namely the layer 0, the layer 1, and the layer 2. However, this is merely an example, and the optical disk 1 may be configured by two layers, or three or more layers such as four layers.

(1-10) In the above embodiment, the storage system 3 including the optical disk 1 is employed as the object to be monitored. However, the present invention is not limited to this. For example, a storage device such as a hard disk and a tape storage may be employed as the object to be monitored. Furthermore, a device configured by mixing different types of a plurality of storage systems such as the storage system 3 including the optical disk, a hard disk, a tape storage and the like may be employed as the object to be monitored.

(1-11) In the above embodiment, the monitoring device is configured by the monitoring agent unit 6 and the monitoring server 30. However, the present invention is not limited to this. The monitoring device may be configured only by the monitoring server 30, and the monitoring agent unit 6 may be omitted. In this case, the monitoring manager unit 9 simply transmits a performance value acquisition signal to the storage system 3 directly, and receives a performance value responded from the storage system 3.

The monitoring server 30 may be configured by a computer including an external storage device such as a CPU, a ROM, a RAM, a communication device, and a hard disk, and the like. In this case, the change necessity determination unit 12, the communication information amount computation unit 14, the time interval computation unit 15, and the time interval update unit 16 are implemented by the execution of programs stored in the ROM by the CPU. Additionally, the time interval holding unit 10, the performance value holding unit 11, and the determination reference holding unit 13 are implemented by a storage device such as a hard disk and a RAM. Furthermore, the monitoring manager unit 9 is implemented by the CPU and the communication device.

Herein, as the communication device included by the monitoring server 30, a communication device for connecting the monitoring server 30 to the Internet may be employed in a case where the monitoring server 30 and the monitoring agent unit 6 are connected via the Internet, and a communication device for connecting the monitoring server 30 to the LAN may be employed in a case where the monitoring server 30 and the monitoring agent are connected via the LAN. The monitoring server 30 may be configured by a dedicated hardware circuit.

The monitoring agent unit 6 may be configured by a dedicated hardware circuit, or may be implemented by a computer including a CPU, a ROM, a RAM, a communication device, and the like. In a case where the monitoring agent unit 6 is implemented by the computer, the performance value acquisition unit 4 and the performance value transmission unit 5 are implemented by the CPU and the communication device.

The storage system 3 further includes a control circuit (not shown) in addition to the optical disk 1 and the drive 2. This control circuit includes, for example, a computer including a CPU, a ROM, a RAM, and the like, or a communication interface for communicating the dedicated hardware circuit (for example, ASIC, FPGA, or the like), and the monitoring agent unit 3. Then, the storage system 3 receives an acquisition instruction from the monitoring agent unit 6, and transmits a performance value to the monitoring agent unit 6 through this communication interface.

(1-12) In this embodiment, the time interval holding unit 10, the performance value holding unit 11, and the determination reference holding unit 13 are represented by other blocks. However, these holding units may be implemented by a single storage device.

(1-13) In this embodiment, the monitoring agent unit 6 transmits an acquisition instruction to the storage system 3 in accordance with the performance value acquisition command signal from the monitoring manager unit 9. The monitoring agent unit 6 singly transmits the acquisition instruction to the storage system 3 regularly, and holds a performance value responded from the storage system 3. Then, the monitoring manager unit 9 may employ a configuration of reading the performance value held by the monitoring agent unit 6 at a predetermined time interval.

In this case, the monitoring agent unit 6 may measure the number of accesses or the access amount of the storage system 3, or the acquisition processing time required for acquiring a performance value, and singly determine the necessity of the change of the monitoring time interval on the basis of the measurement result.

(1-14) In this embodiment, the monitoring server 30 includes the single monitoring manager unit 9. However, the present invention is not limited to this, and the monitoring server 30 may include a plurality of the monitoring manager units 9.

(1-15) In this embodiment, the monitoring manager unit 9 corresponds to the monitoring agent unit 6 one-on-one. However, the single monitoring manager unit 9 may correspond to a plurality of the monitoring agent units 6. In this case, the change necessity determination unit 12 may determine the necessity of the change of the monitoring time interval for each monitoring agent unit 6, or may determine the necessity of the monitoring time interval by defining the plurality of monitoring agent units 6 as a single unit.

(1-16) In this embodiment, the monitoring agent unit 6 corresponds to the storage system 3 one-on-one. However, the single monitoring agent unit 6 may correspond to a plurality of the storage system 3. In this case, the change necessity determination unit 12 may determine the shortening, the extension, and no change of the monitoring time interval for each monitoring agent unit 6, or in a storage group unit configured from the plurality of storage system 3.

(1-17) In this embodiment, the time interval table shown in FIG. 2 includes the fields of the item identification information, the monitoring time interval, the information size, the initial interval, and the shortening interval. However, the time interval is not limited to this, and may include the field of threshold value corresponding to each performance item, a priority level, or the like.

(1-18) Although the performance value table shown in FIG. 4 holds the performance value history in the predetermined period in this embodiment, the performance value table may hold a performance value history in all periods from when the storage system 3 starts working till the present, may hold only a performance value history in the latest time, or may hold a threshold value that is the determination reference of the necessity of the change of the monitoring time interval for each performance item.

(1-19) The monitoring agent unit 6 may be configured by a dedicated device that is a separated body from the storage system 3, or may be configured by a device configuring the storage system 3 (for example, a control circuit). Additionally, the monitoring agent unit 6 and the monitoring manager unit 9 may be configured by a device configuring the storage system 3 (for example, a control circuit). Additionally, the monitoring manager unit 9 may be configured by a dedicated device that is a separated body from the storage system 3. Furthermore, the monitoring agent unit 6 and the monitoring manager unit 9 may be configured by the same device that is a separated body from the storage system 3.

(1-20) Although the change necessity determination unit 12 performs a process shown in FIG. 7A and FIG. 7B to determine the necessity of the change of the monitoring time interval in this embodiment, the change necessity determination unit 12 may store the determination result of the necessity of the change of the monitoring time interval for each time, and determine the necessity of the change of the monitoring time interval in the subsequent time from the trend of a past determination result when the stored number of the determination results is a fixed number or more. Consequently, it is possible to speed up the determination process of the change necessity determination unit 12.

(1-21)

The change necessity determination unit 12 may determine the performance items of the optical disk 1 in preference to the performance items of the drive 2, as the performance items for which the monitoring time intervals are to be shortened. For example, in a case where the change necessity determination unit 12 determines in accordance with the determination reference shown in FIG. 5 that a monitoring time interval for a certain performance item of the drive 2 needs to be shortened, when the change necessity determination unit 12 also determines that a monitoring time interval for a certain performance item of the optical disk 1 needs to be shortened, the change necessity determination unit 12 may determine that only the monitoring time interval for the performance item of the optical disk 1 needs to be shortened.

(1-22)

The change necessity determination unit 12 may determine the performance items of the drive 2 in preference to the performance items of the optical disk 1, as the performance items for which the monitoring time intervals are to be shortened. For example, in a case where the change necessity determination unit 12 determines in accordance with the determination reference shown in FIG. 5 that a monitoring time interval for a certain performance item of the optical disk 1 needs to be shortened, when the change necessity determination unit 12 also determines that a monitoring time interval for a certain performance item of the drive 2 needs to be shortened, the change necessity determination unit 12 may determine that only the monitoring time interval for the performance item of the drive 2 needs to be shortened.

(1-23)

Although the monitoring time interval of the performance item, which is determined to need to be shortened, is changed to the shortening interval registered in the field of the shortening interval in this embodiment, the shortening width may be registered in this field, and the monitoring time interval may be gradually shortened for each shortening width. For example, in a case where 100 seconds are registered as the shortening width, when the monitoring time interval for the disk performance item A is shortened, the monitoring time interval may be first shortened from 400 seconds to 300 seconds. Then, when the monitoring time interval is thereafter shortened, the monitoring time interval may be gradually shortened from 300 seconds to 200 seconds.

### Embodiment 2

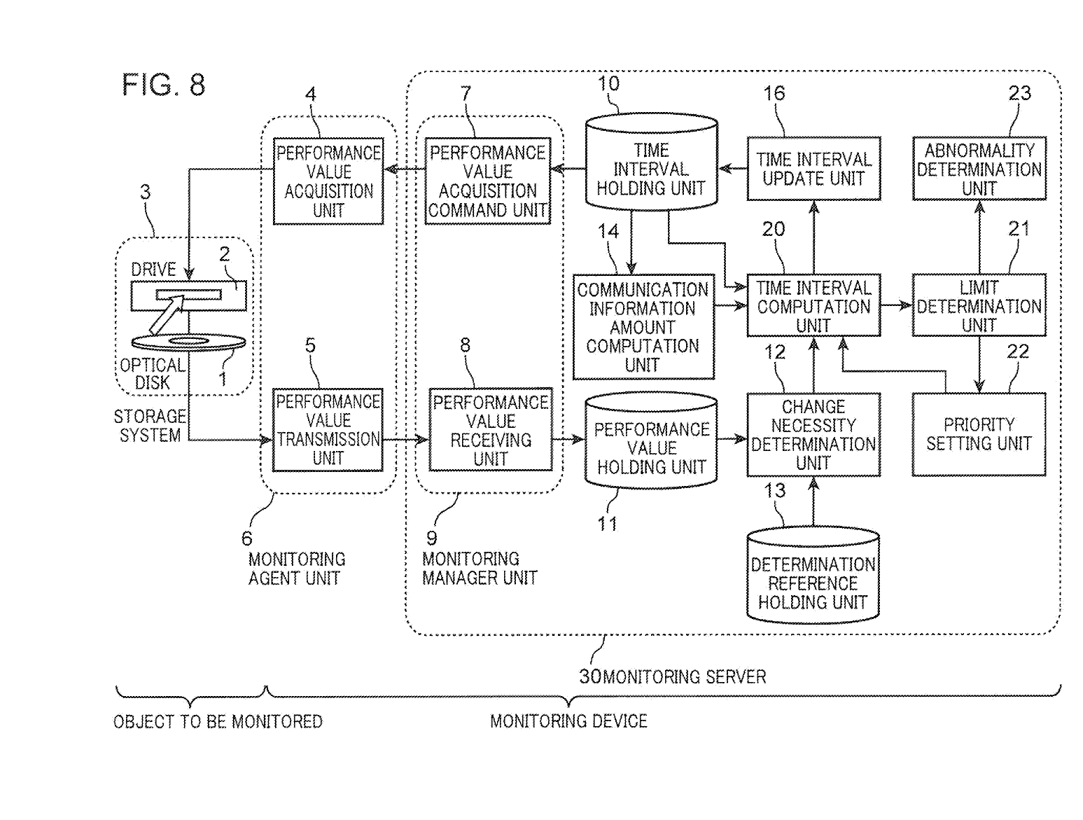

FIG. 8 is a block diagram showing a configuration of a monitoring system to which a monitoring device according to Embodiment 2 is applied. In FIG. 8, an optical disk 1, a drive 2, a storage system 3, a performance value acquisition unit 4, a performance value transmission unit 5, a monitoring agent unit 6, a performance value acquisition command unit 7, a performance value receiving unit 8, a monitoring manager unit 9, a time interval holding unit 10, a performance value holding unit 11, a change necessity determination unit 12, a determination reference holding unit 13, a communication information amount computation unit 14, and a time interval update unit 16 have the same functions as those of Embodiment 1, and therefore description is omitted.

The difference from Embodiment 1 is that a monitoring server 30 includes a time interval computation unit 20, a limit determination unit 21, a priority setting unit 22, and an abnormality determination unit 23, and the function of the time interval computation unit 20 is different from the function of the time interval computation unit 15 in FIG. 1. By these functions, the monitoring device of Embodiment 2 can determine that a monitoring time interval of any of a large number of performance items for which the monitoring time intervals are determined to need to be shortened is extended in accordance with priority levels. Consequently, a monitoring time interval for a performance item whose priority level is low can be prevented from being unnecessarily shortened, and the communication information amount of the whole of the monitoring system can be more reliably suppressed to a predetermined amount or less.

The time interval computation unit 20 is implemented, for example, by execution of a program stored in a ROM by a CPU, and calculates a new time interval by using a priority level for each performance item preset by the priority setting unit 22, in addition to a determination result output from the change necessity determination unit 12, a communication information amount output from the communication information amount computation unit 14, and a monitoring time interval of each performance item read from the time interval holding unit 10.

The time interval computation unit 20 previously holds an upper limit of a monitoring time interval for each performance item. Then, in a case where a computation result of a monitoring time interval of a performance item for which the monitoring time interval is determined to need to be extended by the change necessity determination unit 12 is the upper limit or more, the time interval computation unit 20 performs a rounding process of setting the computation result to the upper limit.

In this case, in a case where the time interval computation unit 20 performs the rounding process to all performance items determined to need to be extended by the change necessity determination unit 12, the change necessity determination unit 12 determines that the monitoring time interval of the performance item for which the monitoring time interval is determined to need to be shortened by the change necessity determination unit 12 is in a limit state where the monitoring time interval cannot be shortened any more, and outputs the determination result to the limit determination unit 21.

The limit determination unit 21 is implemented, for example, by execution of a program stored in the ROM by the CPU. When receiving the determination result indicating that the monitoring time interval is in the limit state, from the time interval computation unit 20, the limit determination unit 21 outputs a setting request for setting a priority level to the performance item, for which the monitoring time interval is shortened, to the priority setting unit 22.

The priority setting unit 22 is implemented, for example, by execution of a program stored in the ROM by the CPU. Then, when receiving the setting request output from the limit determination unit 21, the priority setting unit 22 performs priority monitoring necessity setting of causing the time interval computation unit 20 to select a performance item, for which the monitoring time interval is actually shortened, among the performance items, for which the monitoring time intervals are determined to need to be shortened by the change necessity determination unit 12, and ouputs a recomputation request of the monitoring time interval for each performance item, to the time interval computation unit 20. Herein, the priority setting unit 22 previously hold priority monitoring necessity information in which the priority level for each performance item is preset, and outputs this priority monitoring necessity information along with the recomputation request to the time interval computation unit 20.

In a case where the limit determination unit 21 determines that the monitoring time interval is in the limit state, the abnormality determination unit 23 determines that the monitoring system is in an abnormal state, and notifies an operator of the monitoring server 30 that the monitoring system is in the abnormal state. Herein, the abnormality determination unit 23 is configured, for example, by a display device such as a liquid crystal panel, a display control device for controlling the display device, and a CPU for outputting a drawing instruction to the display control device, and the like. Then, the abnormality determination unit 23 causes the display device to display an image including wording indicating that the monitoring time interval for the performance item, which is determined to need to be shortened, cannot be shortened any more.

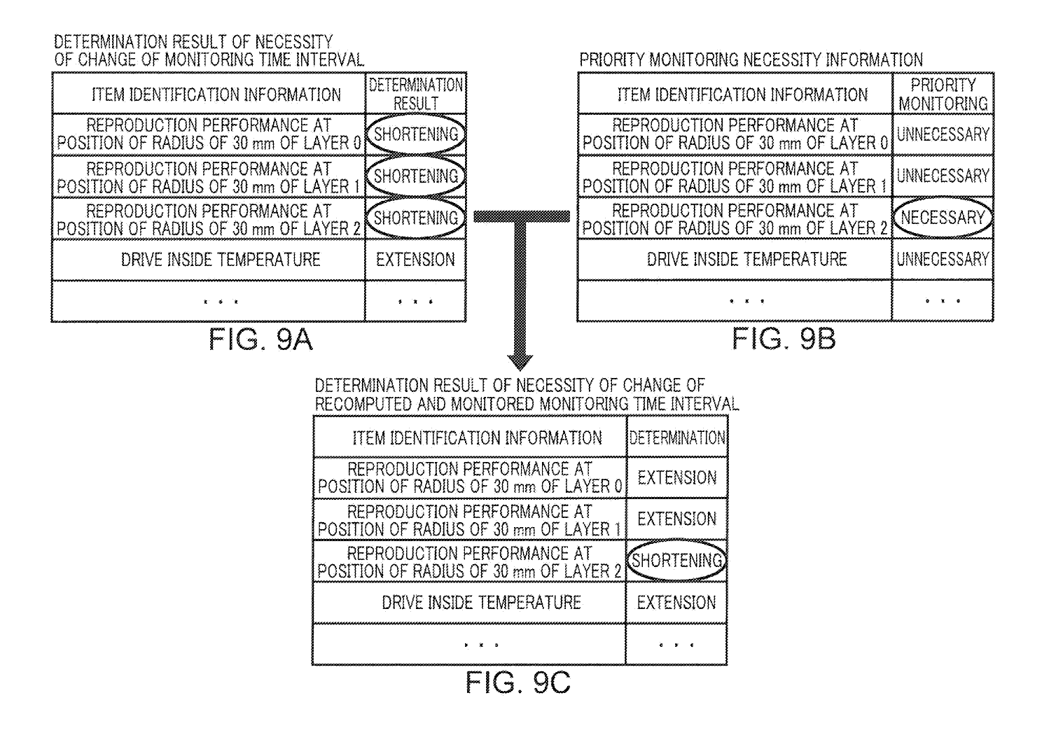

FIG. 9 are figures showing a process of the time interval computation unit 20 performed in a case of receiving a recomputation request from the priority setting unit 22. FIG. 9A is a table showing an example of a determination result of the necessity of the change of a monitoring time interval for each performance item output from the change necessity determination unit 12. FIG. 9B is a table showing an example of priority monitoring necessity information held by the priority setting unit 22.

In a case where the optical disk 1 is configured by a plurality of layers, the priority setting unit 22 previously holds priority monitoring necessity information in which a layer closer to the disk surface is more preferentially monitored. That is, in the example of FIG. 9B, a layer 2 is the closest to the disk surface, a layer 1 is the next closest to the disk surface, and a layer 0 is the next closest to the disk surface. Therefore, in the priority monitoring necessity information shown in FIG. 9B, “necessary” is registered in the field of “priority monitoring” of the layer 2 close to the disk surface, “unnecessary” is registered in each of the fields of “priority monitoring” of the layer 0 and the layer 1. Thus, in the priority monitoring necessity information shown in FIG. 9B, the priority level for each performance item is set such that the priority level for the performance item of the layer 2 is higher than the priority level for each performance item of the layer 0 and the layer 1.

When receiving a recomputation request from the priority setting unit 22, the time interval computation unit 20 determines that a monitoring time interval for a performance item for which the monitoring time interval is determined to need to be shortened by the change necessity determination unit 12, and for which priority monitoring is set to be necessary by the priority setting unit 22, needs to be shortened, in reference to the determination result of the necessity of the change of the monitoring time interval shown in FIG. 9A, which is output from the change necessity determination unit 12, and the priority monitoring necessity information shown in FIG. 9B, which is held by the priority setting unit 22.

FIG. 9C is a figure showing an example of the determination result of the necessity of the change of the monitoring time intervals recomputed by the time interval computation unit 20. As to the performance items of the layer 0 and the layer 1, while “determination result” shows “shortened” in the example of FIG. 9A, “unnecessary” is registered in “priority monitoring” shown in FIG. 9B. Therefore, the time interval computation unit 20 changes from the determination that the monitoring time intervals for the performance items of the layer 0 and the layer 1 need to be shortened to the determination that these monitoring time interval need to be extended (FIG. 9C).

Additionally, as to the performance item of the layer 2, while “determination result” shows “shortened” in the example of FIG. 9A, “necessary” is registered in “priority monitoring” shown in FIG. 9B. Therefore, the time interval computation unit 20 maintains the determination that the monitoring time interval for the performance item of the layer 2 needs to be shortened (FIG. 9C).

Furthermore, as to the performance item of the drive, while “unnecessary” is registered in “priority monitoring” shown in FIG. 9B, “determination result” shows “extended” in the example of FIG. 9A. Therefore, the time interval computation unit 20 maintains the determination that the monitoring time intervals for the performance item of the drive needs to be extended (FIG. 9C).

Then, the time interval computation unit 20 recomputes the monitoring time interval for each performance item in accordance with the recomputed determination result shown in FIG. 9C, and outputs the computation result of the recomputed monitoring time intervals to the time interval update unit 16. Herein, the time interval computation unit 20 simply computes the monitoring time intervals by a method used in Embodiment 1. That is, the time interval computation unit 20 may calculate the monitoring time interval of each performance item such that the total of the communication information amounts per unit time of all performance items is not greater than a predetermined value, or may calculate the monitoring time interval of each performance item such that the acquisition processing time of each performance value is not greater than the predetermined value.

Thus, according to the monitoring device of Embodiment 2, in a case where a rounding process is performed for all performance items, for which the monitoring time intervals are determined to need to be extended by the change necessity determination unit 12, it is determined that performance items, for which the monitoring time intervals are determined to need to be shortened by the change necessity determination unit 12, are in a limit state where the monitoring time interval cannot be shortened any more. Then, performance items, for which the monitoring time intervals are to be shortened, among the performance items, for which the monitoring time intervals are determined to need to be shortened, are narrowed in accordance with the priority level set by the priority setting unit 22. Therefore, a monitoring time interval for a performance item whose priority level is low can be prevented from being unnecessarily shortened, and the communication information amount of the whole of the monitoring system can be more reliably suppressed to a predetermined amount or less.

(2-1) In this embodiment, in a case where the computation result of the monitoring time interval of the performance item for which the monitoring time interval needs to be extended is the upper limit or more in the time interval computation unit 20, the rounding process for setting a new monitoring time interval to the upper limit is performed. However, in a case where the computation result is the upper limit or more, monitoring of the relevant performance item may be stopped.

(2-2) In this embodiment, the priority setting unit 22 sets the priority level such that the layer closer to the disk surface is more preferentially monitored. However, the present invention is not limited to this. For example, the priority setting unit 22 may set the priority level so as to give priority to a performance item whose performance value change ratio is larger, may set the priority level so as to give priority to a performance item whose timing of determining that the monitoring time interval needs to be shortened is earlier, or may set the priority level so as to give priority to a performance item whose difference between the performance value and a predetermined threshold value is smaller.

The priority setting unit 22 may set the priority level so as to give priority to a performance item whose difference between the present value of the performance value and the predetermined threshold value is smaller than the difference between a normal value and the present value, may set the priority level so as to give priority to the performance items related to the optical disk 1, or may set the priority level so as to give priority to the performance items related to the drive 2.

The priority setting unit 22 may set the priority level so as to give priority to a performance item indicating reproduction performance in the performance items related to the optical disk 1, may set the priority so as to give priority to a performance item indicating a recording performance in the performance items related to the optical disk 1, or may set the priority level so as to give priority to a performance item indicating laser output performance in the performance item related to the drive 2.

The priority setting unit 22 may set the priority level so as to give priority to a performance item whose performance value proceeds to deteriorate, which cannot be recovered even when an object to be monitored performs as retry process, or may set the priority level so as to give priority to a performance item whose measurement position is located on the outer peripheral side of the optical disk 1 in the performance items related to the optical disk 1.

The priority setting unit 22 may set the priority level so as to give priority to a performance item, in which the inner temperature of the object to be monitored or the outer temperature of the object to be monitored when the performance value is measured is higher than a predetermined temperature, or may set the priority level so as to give priority to a performance item in which the inner temperature of the object to be monitored or the outer temperature of the object to be monitored when the performance value is measured is lower that the predetermined temperature.

The priority setting unit 22 may set the priority level so as to give priority to a performance item whose information size is small, or may set the priority level such that a performance item, for which the monitoring time interval is to be shortened, is not added any more.

The priority setting unit 22 may set the priority level such that a performance item, for which the monitoring time interval is shortened, is not added any more, in a case where the total of the information sizes of all performance items, for which the monitoring time intervals are shortened, is a predetermined value or more, or may set the priority level such that a performance item, for which the monitoring time interval is shortened, is not added any more, in a case where the number of items of performance items, for which the monitoring time intervals are shortened, is a predetermined or more.

The priority setting unit 22 may set the priority level so as to give priority to a performance item of the optical disk 1 or the drive 2 whose lifetime is close to end, in a case where a plurality of the optical disks 1 or a plurality of the drives 2 are monitored.

In a case where a plurality of the optical disks 1 or a plurality of the drives 2 are monitored, when the optical disks 1 or the drives 2 whose production lots are the same are present, the priority setting unit 22 may set the priority level so as to give priority to a performance item of the optical disk 1 or the drive 2 whose lifetime is the shortest among the optical disks 1 or the drives 2 whose production lots are the same.

In a case where a plurality of the optical disks 1 or a plurality of the drives 2 are monitored, when the optical disks 1 or the drives 2 whose production lots are the same are present, the priority setting unit 22 may set the priority level so as to give priority to a performance item of any of the optical disks 1 or the drives 2.

In a case where a plurality of groups of the storage systems 3 whose production lots are the same are present, the priority setting unit 22 may set the priority level by changing the groups of the storage systems 3 whose production lots are the same, in rotation at a predetermined time interval.

(2-3) In this embodiment, the monitoring server 30 includes the priority setting unit 22. However, the priority setting unit 22 may be omitted. In this case, the time interval computation unit 20 simply recomputes a monitoring time interval, even in a case where the monitoring time interval is determined to be in the limit state by the limit determination unit 21.

(2-4) Also in this embodiment, the modifications shown in (1-1) to (1-23) described in Embodiment 1 may be employed.

### Other Embodiments

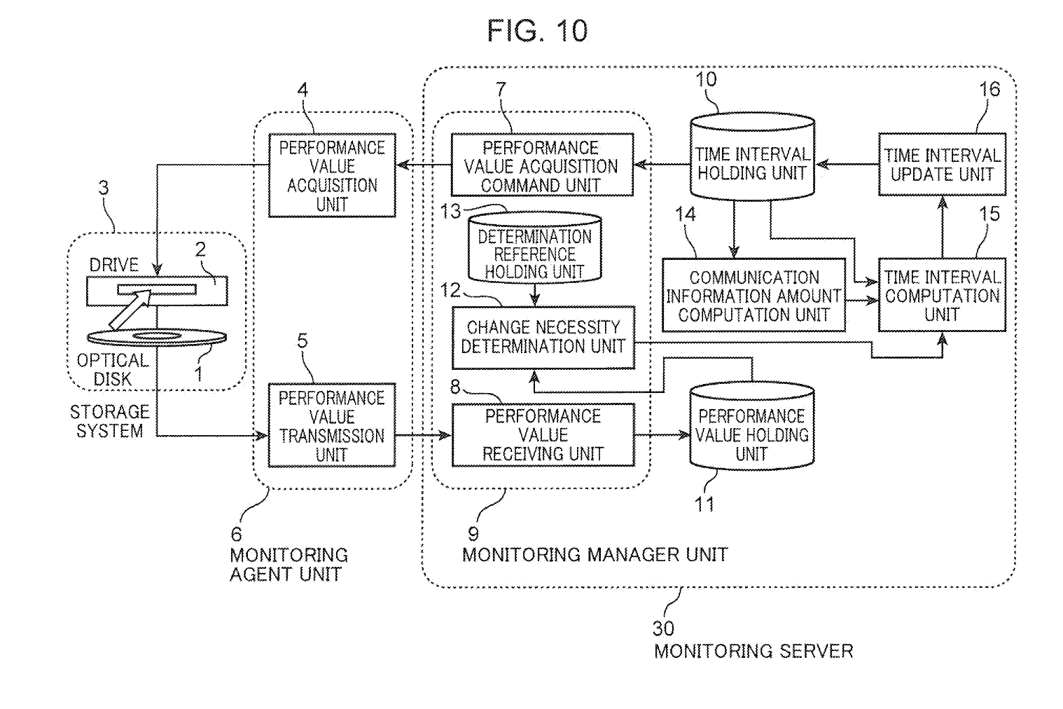

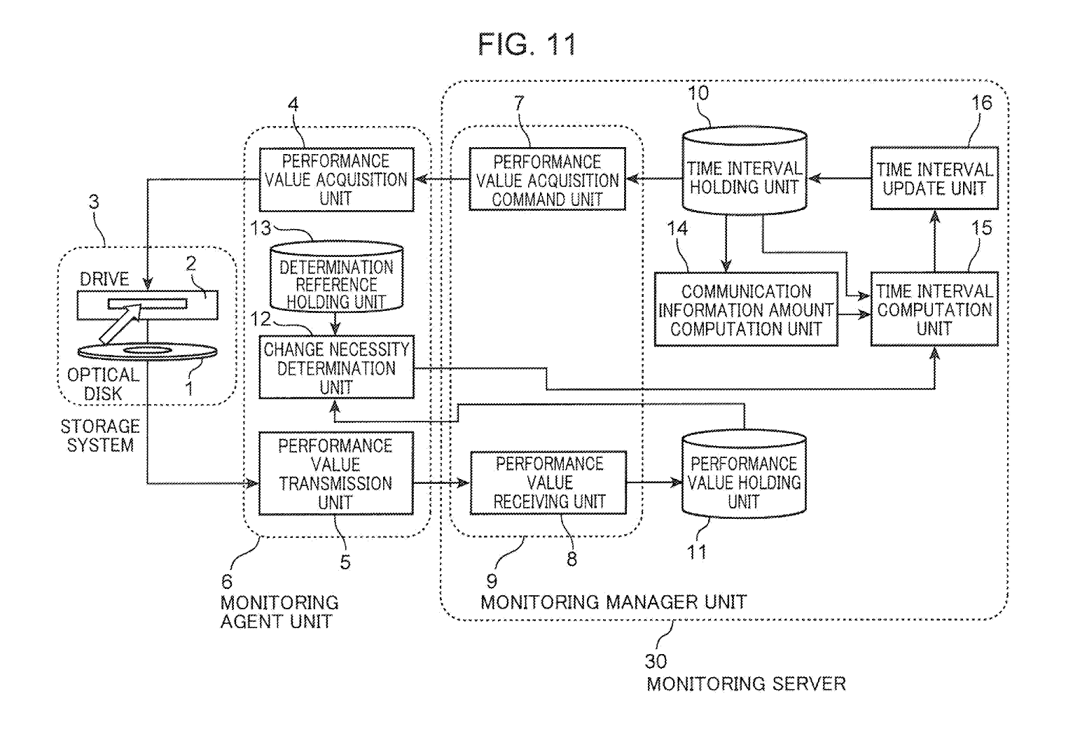

(3-1) In FIG. 1 and FIG. 8, the change necessity determination unit 12 and the determination reference holding unit 13 are provided in the monitoring server 30 and outside the monitoring manager unit 9. However, as shown in FIG. 10, the change necessity determination unit 12 and the determination reference holding unit 13 may be provided in the monitoring manager unit 9. Additionally, as shown in FIG. 11, the change necessity determination unit 12 and the determination reference holding unit 13 may be provided in the monitoring agent unit 6. In the configuration of FIG. 11, the change necessity determination unit 12 may be configured by a communication device included by the monitoring agent unit 6, and a CPU for controlling the communication device, and the like. Then, the change necessity determination unit 12 simply receives/transmits various data from/to the monitoring server 30 by using the communication device.

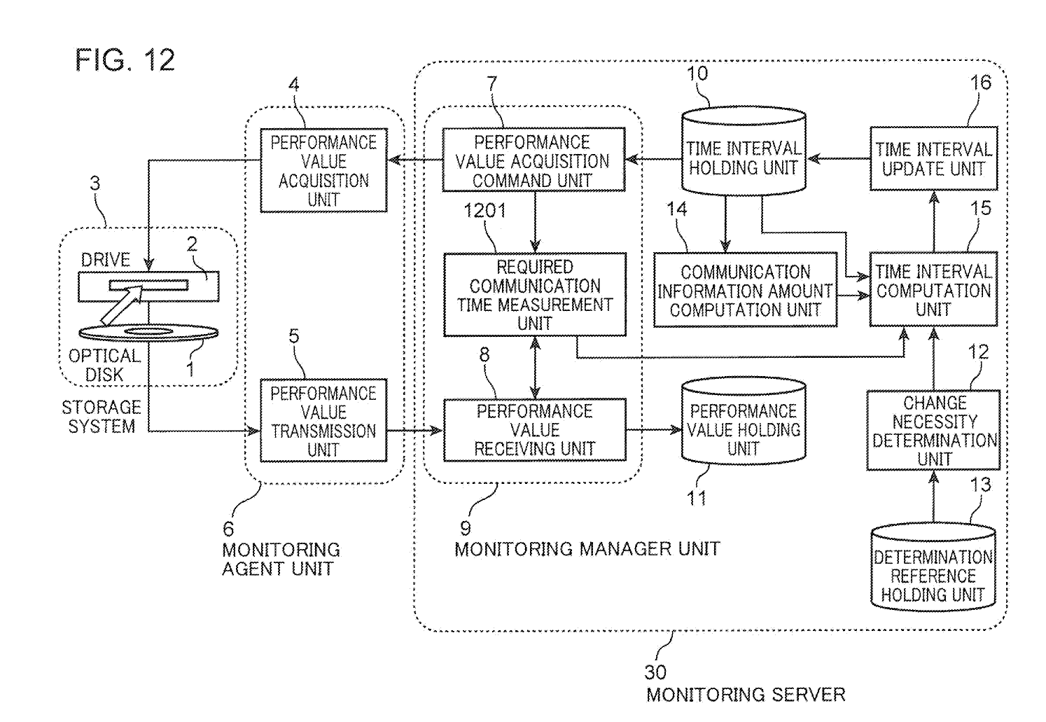

(3-2) In (1-6) described above, the time interval computation unit 15 calculates the monitoring time interval of each performance item such that the acquisition processing time measured by the monitoring agent unit 6 is not greater than a predetermined value. However, as shown in FIG. 12, a required communication time measurement unit 1201 is provided in the monitoring manager unit 9, and the monitoring time interval of each performance item may be calculated such that a required communication time measured by the required communication time measurement unit 1201 is not greater than a predetermined value. Herein, the required communication time is time from when the performance value acquisition command unit 7 transmits a performance value acquisition command signal to when the performance value receiving unit 8 receives a corresponding performance value. A detailed process of calculating the monitoring time interval of each performance item by using the required communication time by the time interval computation unit 15 is sufficient to be read while replacing the acquisition processing time in (1-6) with the required communication time, and therefore detailed description is omitted.

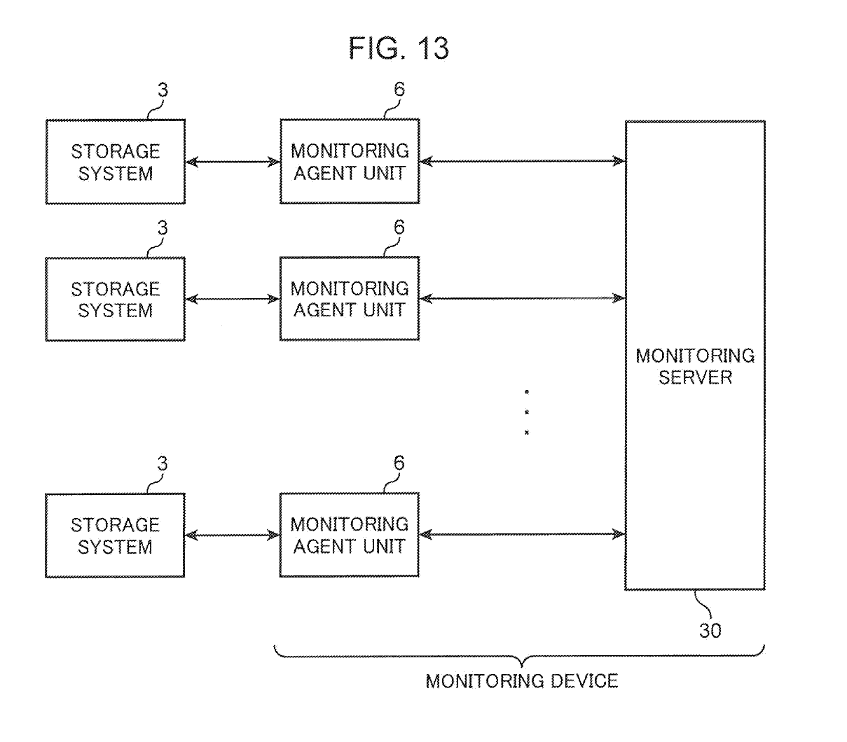

(3-3) In FIG. 1 and FIG. 8, the number of the monitoring agent units 6 and the number of the storage systems 3 each are one. However, as shown in FIG. 13, a plurality of the monitoring agent units 6 and a plurality of the storage systems 3 may be provided. FIG. 13 is a figure showing a configuration of a monitoring system provided with the plurality of monitoring agent units and the plurality of storage systems. In the example of FIG. 13, the number of the storage systems 3 and the number of the monitoring agent units 6 are the same, and the storage systems 3 and the monitoring agent units 6 are provided such that the storage systems 3 correspond to the monitoring agent units 6 one-on-one.

In this case, the change necessity determination unit 12 simply determines the necessity of the change of the monitoring time interval for each storage system 3. For example, in a case where it is determined that a monitoring time interval of a certain performance item of a certain storage system 3 needs to be shortened, the change necessity determination unit 12 simply decides a performance item for which the monitoring time interval is to be extended, from among other performance items of the same storage system 3.

Additionally, the change necessity determination unit 12 may determine the shortening and the extension of the monitoring time intervals for different storage systems 3 in relation to each other. For example, in a case where the change necessity determination unit 12 determines that a monitoring time interval of a certain performance item of a certain storage system 3 needs to be shortened, the change necessity determination unit 12 simply decides a performance item for which the monitoring time interval is to be extended from among performance items of other storage system 3. In this case, the change necessity determination unit 12 simply preferentially decides a performance item of a storage system 3 whose deterioration is less, as an object, for which the monitoring time interval is to be extended. Consequently, monitoring frequency to a certain storage system 3 is made higher, and monitoring frequency to other storage system 3 is made lower.

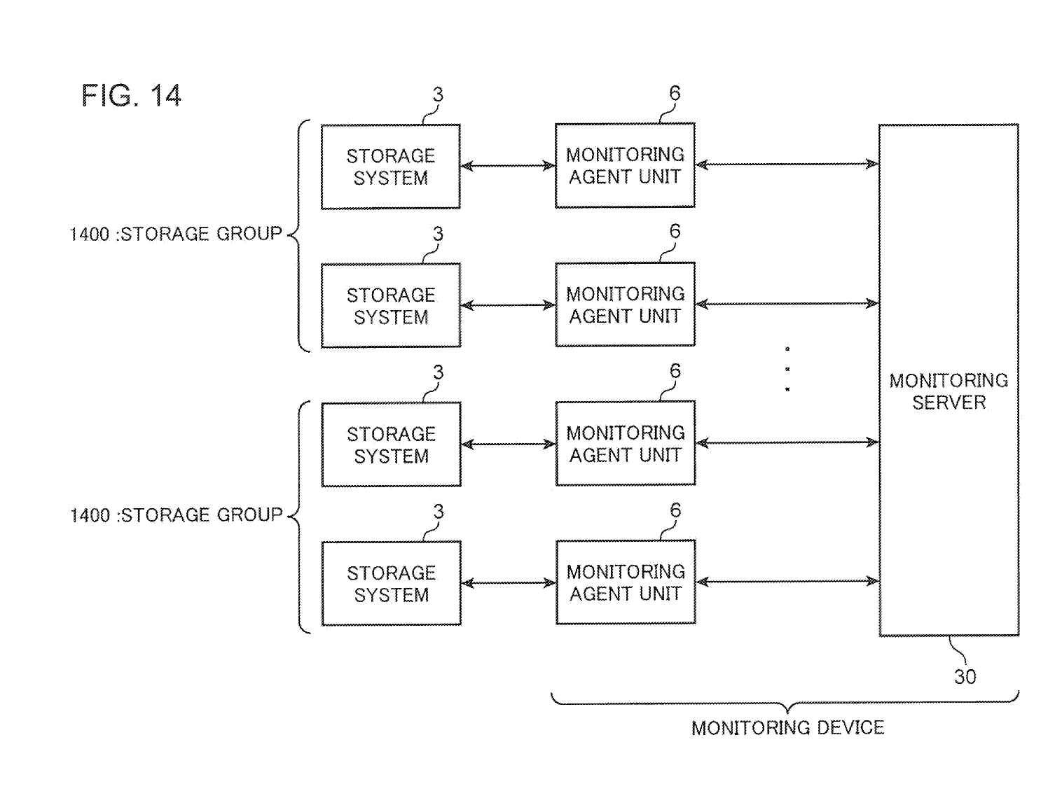

(3-4) In the monitoring device, a plurality of storage groups including a plurality of the storage systems 3 may be defined as objects to be monitored. FIG. 14 is a block diagram of a monitoring system when the plurality of storage groups are defined as the object to be monitored. In FIG. 14, a plurality of storage groups 1400 are included. The single storage group 1400 includes a plurality of the storage system 3. Additionally, the monitoring agent units 6 correspond to the storage systems 3 one-on-one.

In this case, the change necessity determination unit 12 simply determines the necessity of the change of monitoring time intervals for the different storage groups 1400 in relation to each other. For example, in a case where the change necessity determination unit 12 determines that a monitoring time interval of a certain performance item of the certain storage group 1400 needs to be shortened, the change necessity determination unit 12 simply decides a performance item for which the monitoring time interval is to be extended, from among performance items of other storage group 1400. In this case, the change necessity determination unit 12 simply preferentially decides a performance item of a storage group 1400 whose deterioration is less, as a performance item, for which the monitoring time interval is to be extended. Consequently, monitoring frequency to a certain storage group 1400 is made higher, and monitoring frequency to the other storage group 1400 is made lower.

(3-5) In each of Embodiments 1 and 2, the time interval computation unit 15 sets the monitoring time interval of each performance item such that the communication information amount per unit time is not greater than the predetermined value, or the acquisition processing time required for acquiring the performance value is not greater than the predetermined value. However, the present invention is not limited to this, and the monitoring time interval of each performance item may be set such that the number of times of monitoring per unit time is not greater than a predetermined value.

For example, a case where monitoring time intervals of the disk performance items A and B of FIG. 2 are determined to need to be shortened, and monitoring time intervals of the disk performance items C and D are determined to need to be extended is considered. In this case, the time interval computation unit 15 obtains the increase amount of the number of times of monitoring per unit time, by deducting the total of the numbers of the times of monitoring per unit time of all performance items before the shortening of the monitoring time intervals, from the total of the numbers of the times of monitoring per unit time of all performance items after the shortening of the monitoring time intervals, in accordance with information registered in the time interval table in FIG. 2. Then, the time interval computation unit 15 simply extends the monitoring time intervals of the disk performance items C and D, and makes the disk performance items C and D absorb this increase amount such that the number of times of monitoring per unit time is not greater than a predetermined number of times.

(3-6) In the example of FIG. 6, the change necessity determination unit 12 calculates the predicted time Tc by using the extrapolation method, and determines the necessity of the change of the monitoring time interval. However, the present invention is not limited to this. For example, in a case where a performance value of a certain single performance item is out of a predetermined range, or in a case where a change amount of a performance value of a certain single performance item is out of a predetermined range, the change necessity determination unit 12 may determine that the monitoring time interval needs to be changed. Or, in a case where a performance value of a performance item indicating an access amount to an object to be monitored is larger than a predetermined value, in a case where a performance value of a performance item indicating an acquisition processing time required for performing a process of acquiring a performance value of each performance item from an object to be monitored is larger than a predetermined value, or in a case where a required communication time from when the monitoring manager unit 9 transmits a performance value acquisition command signal to when a performance value of each performance item is received is larger than a predetermined value, the change necessity determination unit 12 may determine that the monitoring time interval needs to be changed.

As a specific example in which the change amount of the performance value is out of the predetermined range, in FIG. 6, in a case where a performance value in the latest time greatly deviates from the approximation straight line L1 calculated last time, that is, in a case where the difference between the approximation straight line L1 and the performance value in the latest time is a threshold value or more, there is a possibility that the relevant performance item is rapidly deteriorated, and therefore the change necessity determination unit 12 may determine that the monitoring time interval needs to be shortened. Herein, as the performance value, the error rate, the jitter, or the MLSE can be employed.

### Summary of Embodiments

(1) A monitoring device of this embodiment is a monitoring device for monitoring a plurality of performance items each indicating performance of an object to be monitored, at a predetermined time interval, and which includes: a time interval holding unit that holds a monitoring time interval corresponding to each performance item; a monitoring manager unit that transmits, to the object to be monitored, a performance value acquisition command signal for acquiring a performance value of each performance item at the monitoring time interval held by the time interval holding unit, and receives the performance value of each performance item returned from the object to be monitored; a performance value holding unit that holds the performance value of each performance item, which is received by the monitoring manager unit; a determination unit that determines necessity of change of the monitoring time interval of each performance item from the performance value of at least one performance item held by the performance value holding unit; a time interval computation unit that shortens a monitoring time interval of a performance item for which the monitoring time interval is determined to need to be shortened by the determination unit, and extends a monitoring time interval of an arbitrary performance item other than the performance item for which the monitoring time interval is determined to need to be shortened; and a time interval update unit that updates the monitoring time interval held by the time interval holding unit, to the monitoring time interval of each performance item, which is computed by the time interval computation unit.

According to this configuration, in the case where the monitoring time interval of the certain performance item is shortened, the monitoring time interval of other performance item is extended. Therefore, the increase amount of a monitoring load due to the shortening of the monitoring time interval of the certain performance item is absorbed in the other performance item. As a result, it is possible suppress the increase in the monitoring load of the whole monitoring system, even when the monitoring time interval of the performance item whose performance value proceeds to deteriorate.

(2) In the above configuration, a plurality of the objects to be monitored may be present, and the determination unit may determine shortening and extension of the monitoring time interval for each of the objects to be monitored.

According to this configuration, in the case where the plurality of the objects to be monitored are present, the shortening and the extension of the monitoring time interval is determined for each one object to be monitored, and therefore a monitoring load can be prevented from concentrating on a certain object to be monitored.

(3) In the above configuration, a plurality of the objects to be monitored may be present, and the determination unit may determine shortening and extension of the monitoring time intervals for the objects to be monitored in relation to each other.

According to this configuration, in the case where the plurality of the objects to be monitored are present, the shortening and the extension of the monitoring time intervals are determined for the plurality of objects to be monitored in relation to each other. Therefore, the increase amount of a monitoring load to a certain object to be monitored is absorbed in other object to be monitored, and it is possible to suppress increase in the monitoring load of the whole monitoring system.

(4) In the above configuration, the monitoring device may monitor a plurality of monitoring object groups including a plurality of the objects to be monitored, and the determination unit may determine shortening and extension of the monitoring time intervals for the monitoring object groups in relation to each other.

According to this configuration, the shortening and the extension of the monitoring time intervals are determined for the plurality of objects to be monitored in relation to each other. Therefore, the increase amount of a monitoring load to a certain monitoring object group is absorbed in other monitoring object group, and it is possible to suppress increase in the monitoring load of the whole monitoring system.

(5) In the above configuration, the determination unit may determine that the monitoring time interval needs to be changed, in a case where the performance value of a certain performance item is out of a predetermined range, in a case where a change amount of the performance value of a certain performance item is out of a predetermined range, in a case where, for a certain performance item, a predicted time from a present time point up to a predetermined performance limit of the object to be monitored is shorter than a predetermined time, the predicted time being obtained by extrapolating a plurality of performance values acquired in time series, in a case where a performance value of a performance item indicating an access amount to the object to be monitored is larger than a predetermined value, in a case where a performance value of performance item indicating an acquisition processing time required for performing an acquisition process of the performance value of each performance item from the object to be monitored is larger than a predetermined value, or in a case where a required communication time from when the monitoring manager unit transmits the performance value acquisition command signal to when the monitoring manager unit receives the performance value of each performance item is larger than a predetermined value.

According to this configuration, the object to be monitored can be monitored at a proper frequency not only from a stage in which an abnormal sign of the object to be monitored is seen but also from a stage in which a lifetime is close to end even with no sign. Herein, as the used predetermined value, a value that is preset in accordance with the performance item which shows deterioration is employed.

(6) In the above configuration, the determination unit may be provided in the monitoring manager unit.

According to this configuration, the monitoring manager unit determines the necessity of the change of the monitoring time intervals.

(7) In the above configuration, the monitoring device may further include a monitoring agent unit that receives the performance value acquisition command signal from the monitoring manager unit to transmit the received performance value acquisition command signal to the object to be monitored, and receives the performance value of each performance item, which is returned from the object to be monitored, to transmit the received performance value to the monitoring manager unit, wherein the determination unit may be provided in the monitoring agent unit.

According to this configuration, the monitoring agent unit determines the necessity of the change of the monitoring time intervals.

(8) In the above configuration, the monitoring device may further include a monitoring agent unit that receives the performance value acquisition command signal from the monitoring manager unit to transmit the received performance value acquisition command signal to the object to be monitored, and receives the performance value of each performance item, which is returned from the object to be monitored, to transmit the received performance value to the monitoring manager unit, wherein the monitoring agent unit may measure an acquisition processing time required from acquisition start of the performance value of each performance item from the object to be monitored to acquisition completion, and transmits the measured acquisition processing time to the monitoring manager unit as one of the performance items of the object to be monitored, along with the performance value acquired from the object to be monitored, and the time interval computation unit may compute the monitoring time interval such that the acquisition processing time received by the monitoring manager unit is not greater than a predetermined value.

According to this configuration, the monitoring time interval is computed such that the acquisition processing time required from the acquisition start of the performance value of each performance item to the acquisition completion is not greater than the predetermined value. Therefore, the object to be monitored can be monitored without exerting an adverse influence on original communication of the object to be monitored such as reading and writing of the information of the object to be monitored. As the predetermined value, for example, a preset value capable of preventing an adverse influence on the original communication of the object to be monitored, in consideration of a communication band of a network used for communication by the monitoring device, and the like may be employed.

(9) In the above configuration, the monitoring manager unit may measure a required communication time from when the performance value acquisition command signal is transmitted to when the performance value of each performance item is received, and the time interval computation unit may compute the monitoring time interval such that the required communication time measured by the monitoring manager unit is not greater than a predetermined value.

According to this configuration, the monitoring time interval is computed such that the required communication time from when the performance value acquisition command signal is transmitted to when the performance value item is received is not greater than the predetermined value. Therefore, the object to be monitored can be monitored without exerting an adverse influence on original communication of the object to be monitored such as reading and writing of the information in the object to be monitored.

(10) In the above configuration, the time interval computation unit may compute the monitoring time interval such that a communication information amount per unit time in communication from transmission of the performance value acquisition command signal to acquisition of the performance value of each performance item is not greater than a predetermined value.

According to this configuration, the monitoring time interval is computed such that the communication information amount per unit time in the communication for monitoring the object to be monitored is not greater than the predetermined value. Therefore, the object to be monitored can be monitored without exerting an adverse influence on original communication of the object to be monitored other than the communication for monitoring the object to be monitored.

(11) In the above configuration, the monitoring device may further include a communication information amount measurement device that measures the communication information amount per unit time.

According to this configuration, the communication information amount per unit time can be calculated at a high speed by using a dedicated device for measuring the communication information amount per unit time.

(12) In the above configuration, the time interval holding unit may previously hold an information size indicating a communication information amount corresponding to each performance item, and the monitoring device may further include a communication information amount computation unit that computes the communication information amount per unit time of each performance item from the monitoring time interval and the information size corresponding each performance item.

According to this configuration, the amount of received and transmitted information for acquiring the performance value of each performance item is previously held, and therefore the communication information amount per unit time can be accurately computed at a high speed.

(13) In the above configuration, in a case where a computation result of the monitoring time interval of the performance item, for which the monitoring time interval is determined to need to be extended by the determination unit, is a predetermined value or more, the time interval computation unit may perform a rounding process of setting the computation result to the predetermined value, or makes setting in the time interval holding unit such that monitoring is not performed, and the monitoring device may further include a limit determination unit that determines the monitoring time interval of the performance item, for which the monitoring time interval is determined to need to be shortened by the determination unit, as a limit state where the monitoring time interval is not capable of being shortened any more, in the case where the time interval computation unit performs the rounding process to computation results of all performance items, for which the monitoring time intervals are extended, or in the case where the time interval computation unit makes setting such that the monitoring is not performed.

According to this configuration, the monitoring time interval can be shortened to such a limit as not to exert an adverse influence on original communication of the object to be monitored other than communication for monitoring the object to be monitored. In a case where the rounding process is performed to the monitoring time intervals of all performance items, for which the monitoring time intervals are extended, the monitoring time interval of the performance item for which the monitoring time interval needs to be shortened, is not shortened, and therefore the monitoring load of the whole system can be suppressed to a constant value or less.

(14) In the above configuration, the monitoring device may further include an abnormality determination unit that determines as an abnormal state in a case where the limit determination unit determines as the limit state.

According to this configuration, it is possible to promptly detect the sign of an abnormal state.

(15) In the above configuration, the monitoring device may further include a priority setting unit that sets a priority level for causing the time interval computation unit to select the performance item, for which the monitoring time interval is actually shortened, from among the performance items for which the monitoring time intervals are determined to need to be shortened by the determination unit, in a case where the limit determination unit determines as the limit state.

According to this configuration, in a case where the monitoring time interval reaches the limit state, the monitoring time interval of only the performance item whose monitoring priority level is high, among the performance items for which the monitoring time intervals are determined to need to be shortened by the determination unit, is shortened. Therefore, it is possible to strengthen the monitoring of only the performance item which really needs to be monitored, and to suppress increase in a monitoring load.

(16) In the above configuration, in a case where the object to be monitored includes an information recording carrier having an information surface, and an information recording device that performs at least one of recording and reproduction to and from the information recording carrier, the determination unit may determine that the monitoring time interval of a performance item related to the information recording carrier needs to be shortened, in preference to the monitoring time interval of a performance item related to the information recording device.

According to this configuration, the performance item of the information recording carrier is monitored in preference to the performance item of the information recording device, and therefore it is possible to preferentially detect the deterioration of the read/write performance of data to the information recording carrier, for example.

(17) In the above configuration, in a case where the object to be monitored includes an information recording carrier having an information surface, and an information recording device that performs at least one of recording and reproduction to and from the information recording carrier, the determination unit may determine that the monitoring time interval of a performance item related to the information recording device needs to be shortened, in preference to the monitoring time interval of a performance item related to the information recording carrier.

According to this configuration, it is possible to detect the performance deterioration of the information recording device in preference to the performance deterioration of the information recording carrier.

(18) In the above configuration, in a case where the object to be monitored includes an information recording carrier having an information surface configured by stacking a plurality of layers, the determination unit may determine that, concerning a performance item related to the information recording carrier, the monitoring time interval of a performance item of an information surface located closer to a surface of the information recording carrier needs to be more preferentially shortened.

According to this configuration, it is possible to preferentially detect the sign of the life time of the information surface whose data read/write performance deteriorates at a relatively high speed.

(19) In the above configuration, in a case where the object to be monitored includes an information recording carrier having an information surface, and an information recording device that performs at least one of recording and reproduction to and from the information recording carrier, when the determination unit determines that a monitoring time interval of at least one performance item related to the information recording carrier needs to be shortened, the determination unit may determine that a monitoring time interval of a performance item other than the performance item for which the monitoring time interval is determined to need to be shortened, among the performance items related to the information recording carrier, needs to be extended, and the determination unit may determine that a monitoring time interval of a performance item related to the information recording device does not need to be changed.

According to this configuration, increase in a monitoring load to the information recording carrier can be prevented from having an influence on the information recording device.

(20) In the above configuration, in a case where the object to be monitored includes an information recording carrier having an information surface, and an information recording device that performs at least one of recording and reproduction to and from the information recording carrier, when the determination unit determines that a monitoring time interval of at least one performance item related to the information recording device needs to be shortened, the determination unit may determine that a monitoring time interval of a performance item other than the performance item for which the monitoring time interval is determined to need to be shortened, among the performance items related to the information recording device, needs to be extended, and the determination unit may determine that a monitoring time interval of a performance item related to the information recording carrier does not need to be changed.

According to this configuration, increase in a monitoring load to the information recording device can be prevented from having an influence on the information recording carrier.

(21) In the above configuration, in a case where the object to be monitored includes a plurality of information recording carriers each having an information surface, and a plurality of information recording devices that perform at least one of recording and reproduction to and from the information recording carriers, and the object to be monitored has a redundant configuration in which even when a part of the information recording carriers or a part of the information recording devices is brought into an unusable state, a predetermined usable number is expected such that continuous operation is possible by error correction from other usable information recording carrier and information recording device, the determination unit may determine that monitoring time intervals of performance items related to the information recording carriers and the information recording devices, the numbers of which each corresponding to the usable number, may be extended.

According to this configuration, it is possible to shorten the monitoring time intervals of a larger number of the performance items.

(22) In the above configuration, in a case where the object to be monitored includes an information recording carrier having an information surface, and an information recording device that performs at least one of recording and reproduction to and from the information recording carrier, when a performance value of a performance item indicating an access amount to the object to be monitored from an external device is larger than a predetermined value, the determination unit may determine that a monitoring time interval of a performance item related to the information recording carrier needs to be shortened, and may determine that a monitoring time interval of a performance item related to the information recording device needs to be extended, or does not need to be changed.

According to this configuration, it is possible to detect the sign of the deterioration of the data read/write performance of the information recording carrier in an earlier stage.

### INDUSTRIAL APPLICABILITY

The present invention can be utilized in a monitoring system that remotely monitors states such as the behavior and performance of a remote device via a network.

1-23. (canceled)

24. A monitoring device for monitoring a plurality of performance items each indicating performance of an object to be monitored, at a predetermined time interval, the monitoring device comprising:
a time interval holding unit that holds a monitoring time interval corresponding to each performance item;
a monitoring manager unit that transmits, to the object to be monitored, a performance value acquisition command signal for acquiring a performance value of each performance item at the monitoring time interval held by the time interval holding unit, and receives the performance value of each performance item returned from the object to be monitored;
a performance value holding unit holds the performance value of each performance item, which is received by the monitoring manager unit;
a determination unit that determines, for each performance item, necessity of change of the monitoring time interval of each performance item from the performance value of at least one performance item held by the performance value holding unit;
a time interval computation unit that shortens a monitoring time interval of a performance item for which the monitoring time interval is determined to need to be shortened by the determination unit, and extends a monitoring time interval of an arbitrary performance item other than the performance item for which the monitoring time interval is determined to need to be shortened; and
a time interval update unit that updates the monitoring time interval held by the time interval holding unit, to the monitoring time interval of each performance item, which is computed by the time interval computation unit.

25. The monitoring device according to claim 24, wherein
a plurality of the objects to be monitored are present, and
the determination unit determines shortening and extension of the monitoring time interval for each of the objects to be monitored.

26. The monitoring device according to claim 24, wherein
a plurality of the objects to be monitored are present, and
the determination unit determines shortening and extension of the monitoring time intervals for the objects to be monitored in relation to each other.

27. The monitoring device according to claim 24, wherein
the monitoring device monitors a plurality of monitoring object groups including a plurality of the objects to be monitored, and
the determination unit determines shortening and extension of the monitoring time intervals for the monitoring object groups in relation to each other.

28. The monitoring device according to claim 24, wherein
the determination unit determines that the monitoring time interval needs to be changed,
in a case where the performance value of a certain performance item is out of a predetermined range,
in a case where a change amount of the performance value of a certain performance item is out of a predetermined range,
in a case where, for a certain performance item, a predicted time from a present time point up to a predetermined performance limit of the object to be monitored is shorter than a predetermined time, the predicted time being obtained by extrapolating a plurality of performance values acquired in time series,
in a case where a performance value of a performance item indicating an access amount to the object to be monitored is larger than a predetermined value,
in a case where a performance value of a performance item indicating an acquisition processing time required for performing an acquisition process of the performance value of each performance item from the object to be monitored is larger than a predetermined value, or
in a case where a required communication time from when the monitoring manager unit transmits the performance value acquisition command signal to when the monitoring manager unit receives the performance value of each performance item is larger than a predetermined value.

29. The monitoring device according to claim 24, wherein
the determination unit is provided in the monitoring manager unit.

30. The monitoring device according to claim 24, further comprising
a monitoring agent unit that receives the performance value acquisition command signal from the monitoring manager unit to transmit the received performance value acquisition command signal to the object to be monitored, and receives the performance value of each performance item, which is returned from the object to be monitored, to transmit the received performance value to the monitoring manager unit, wherein
the determination unit is provided in the monitoring agent unit.

31. The monitoring device according to claim 24, further comprising
a monitoring agent unit that receives the performance value acquisition command signal from the monitoring manager unit to transmit the received performance value acquisition command signal to the object to be monitored, and receives the performance value of each performance item, which is returned from the object to be monitored, to transmit the received performance value to the monitoring manager unit, wherein
the monitoring agent unit measures an acquisition processing time required from acquisition start of the performance value of each performance item from the object to be monitored to acquisition completion, and transmits the measured acquisition processing time to the monitoring manager unit as one of the performance items of the object to be monitored, along with the performance value acquired from the object to be monitored, and
the time interval computation unit computes the monitoring time interval such that the acquisition processing time received by the monitoring manager unit is not greater than a predetermined value.

32. The monitoring device according to claim 24, wherein
the monitoring manager unit measures a required communication time from when the performance value acquisition command signal is transmitted to when the performance value of each performance item is received, and
the time interval computation unit computes the monitoring time interval such that the required communication time measured by the monitoring manager unit is not greater than a predetermined value.

33. The monitoring device according to claim 24, wherein
the time interval computation unit computes the monitoring time interval such that a communication information amount per unit time in communication from transmission of the performance value acquisition command signal to acquisition of the performance value of each performance item is not greater than a predetermined value.

34. The monitoring device according to claim 33, further comprising
a communication information amount measurement device that measures the communication information amount per unit time.

35. The monitoring device according to claim 33, wherein
the time interval holding unit previously holds an information size indicating a communication information amount corresponding to each performance item, and
the monitoring device further comprises
a communication information amount computation unit that computes the communication information amount per unit time of each performance item from the monitoring time interval and the information size corresponding each performance item.

36. The monitoring device according to claim 24, wherein
in a case where a computation result of the monitoring time interval of the performance item, for which the monitoring time interval is determined to need to be extended by the determination unit, is a predetermined value or more, the time interval computation unit performs a rounding process of setting the computation result to the predetermined value, or makes setting in the time interval holding unit such that monitoring is not performed, and
the monitoring device further comprises
a limit determination unit that determines the monitoring time interval of the performance item, for which the monitoring time interval is determined to need to be shortened by the determination unit, as a limit state where the monitoring time interval is not capable of being shortened any more, in the case where the time interval computation unit performs the rounding process to computation results of all performance items, for which the monitoring time intervals determined to be extended, or in the case where the time interval computation unit makes setting such that the monitoring is not performed.

37. The monitoring device according to claim 36, further comprising
an abnormality determination unit that determines as an abnormal state in a case where the limit determination unit determines as the limit state.

38. The monitoring device according to claim 36, further comprising
a priority setting unit that sets a priority level for causing the time interval computation unit to select the performance item, for which the monitoring time interval is actually shortened, from among the performance items for which the monitoring time intervals are determined to need to be shortened by the determination unit, in a case where the limit determination unit determines as the limit state.

39. The monitoring device according to claim 24, wherein
in a case where the object to be monitored includes an information recording carrier having an information surface, and an information recording device that performs at least one of recording and reproduction to and from the information recording carrier, the determination unit determines that the monitoring time interval of a performance item related to the information recording carrier needs to be shortened, in preference to the monitoring time interval of a performance item related to the information recording device.

40. The monitoring device according to claim 24, wherein
in a case where the object to be monitored includes an information recording carrier having an information surface, and an information recording device that performs at least one of recording and reproduction to and from the information recording carrier, the determination unit determines that the monitoring time interval of a performance item related to the information recording device needs to be shortened, in preference to the monitoring time interval of a performance item related to the information recording carrier.

41. The monitoring device according to claim 24, wherein
in a case where the object to be monitored includes an information recording carrier having an information surface configured by stacking a plurality of layers, the determination unit determines that, concerning a performance item related to the information recording carrier, the monitoring time interval of a performance item of an information surface located closer to a surface of the information recording carrier needs to be more preferentially shortened.

42. The monitoring device according to claim 24, wherein
in a case where the object to be monitored includes an information recording carrier having an information surface, and an information recording device that performs at least one of recording and reproduction to and from the information recording carrier,
when the determination unit determines that a monitoring time interval of at least one performance item related to the information recording carrier needs to be shortened, the determination unit determines that a monitoring time interval of a performance item other than the performance item for which the monitoring time interval is determined to need to be shortened, among the performance items related to the information recording carrier, needs to be extended, and the determination unit determines that a monitoring time interval of a performance item related to the information recording device does not need to be changed.

43. The monitoring device according to claim 24, wherein
in a case where the object to be monitored includes an information recording carrier having an information surface, and an information recording device that performs at least one of recording and reproduction to and from the information recording carrier,
when the determination unit determines that a monitoring time interval of at least one performance item related to the information recording device needs to be shortened, the determination unit determines that a monitoring time interval of a performance item other than the performance item for which the monitoring time interval is determined to need to be shortened, among the performance items related to the information recording device, needs to be extended, and the determination unit determines that a monitoring time interval of a performance item related to the information recording carrier does not need to be changed.

44. The monitoring device according to claim 24, wherein
in a case where the object to be monitored includes a plurality of information recording carriers each having an information surface, and a plurality of information recording devices that perform at least one of recording and reproduction to and from the information recording carriers, and the object to be monitored has a redundant configuration in which even when a part of the information recording carriers or a part of the information recording devices is brought into an unusable state, a predetermined usable number is expected such that continuous operation is possible by error correction from other usable information recording carrier and information recording device,
the determination unit determines that monitoring time intervals of performance items related to the information recording carriers and the information recording devices, the numbers of which each corresponding to the usable number, may be extended.

45. The monitoring device according to claim 24, wherein
in a case where the object to be monitored includes an information recording carrier having an information surface, and an information recording device that performs at least one of recording and reproduction to and from the information recording carrier,
when a performance value of a performance item indicating an access amount to the object to be monitored from an external device is larger than a predetermined value, the determination unit determines that a monitoring time interval of a performance item related to the information recording carrier needs to be shortened, and determines that a monitoring time interval of a performance item related to the information recording device needs to be extended, or does not need to be changed.

46. A monitoring method performed by a monitoring device for monitoring a plurality of performance items each indicating performance of an object to be monitored, at a predetermined time interval,
the monitoring device including a time interval holding unit that holds a monitoring time interval corresponding each performance item,
the monitoring method comprising:
a transmission and reception step of transmitting, to the object to be monitored, a performance value acquisition command signal for acquiring a performance value of each performance item at the monitoring time interval held by the time interval holding unit, and receiving the performance value of each performance item returned from the object to be monitored;
a holding step of holding, in a performance value holding unit, the performance value of each performance item, which is received in the transmission and reception step;
a determination step of determining, for each performance item, necessity of change of the monitoring time interval of each performance item from the performance value of at least one performance item held by the performance value holding unit;
a time interval computation step of shortening a monitoring time interval of a performance item for which the monitoring time interval is determined to need to be shortened in the determination step, and extending a monitoring time interval of an arbitrary performance item other than the performance item for which the monitoring time interval is determined to need to be shortened; and
a time interval update step of updating the monitoring time interval of each performance item, which is held by the time interval holding unit, to the monitoring time interval of the corresponding performance item, which is computed in the time interval computation step.
